(19) United States
(12) Patent Application Publication
(10) Pub. No.: US 2008/0098226 A1
(43) Pub. Date: Apr. 24, 2008

(54) Encryption communication system, apparatus, method, and program

(75) Inventor: Yuichi Zokumasui, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 11/698,200

(22) Filed: Jan. 26, 2007

(30) Foreign Application Priority Data
Oct. 19, 2006 (JP) 2006-284817

(51) Int. Cl. H04L 9/00

(52) U.S. Cl. 713/171; 713/153

(57) ABSTRACT

A plurality of encryption communication apparatuses to which terminal apparatuses are connected are connected via a network, data received from the terminal apparatus which is a transmission source is encrypted by the encryption communication apparatus and transmitted to the other encryption communication apparatus, and data received from the other encryption communication apparatus is decrypted and transmitted to the terminal apparatus which is a transmission destination. Upon initiation of first communication with the other encryption communication apparatuses, the encryption communication apparatus generates and exchange encryption keys according to an encryption key exchange protocol, records them in the encryption key control table and, and sets validity time so as to control that. The encryption key is subjected to encryption key update when validity time is close; however, even during validity time period, when the state that CPU load is low is determined, the encryption key of the encryption communication apparatus which is a counterpart having a small communication volume is searched, and the encryption key is updated.

This application is a priority based on prior application No. JP 2006-284817, filed Oct. 20, 2006, in Japan.

### BACKGROUND OF THE INVENTION

1. Field of the Invention

The present invention relates to encryption communication system, apparatus, method, and program which encrypt transmitted data and decrypt received data by using encryption keys exchanged between encryption communication apparatuses connected via a network, and particularly relates to encryption communication system, apparatus, method, and program which dynamically control the encryption keys used in encryption and decryption by setting validity time therefor.

2. Description of the Related Arts

Conventionally, in encryption communication, a plurality of encryption communication apparatuses to which terminal apparatuses are connected are connected via a network such as a WAN, wherein a transmitted frame received from a terminal apparatus of a transmission source is encrypted by using an encryption key in an encryption communication apparatus and transmitted to another encryption communication apparatus. The received frame received from the other encryption communication apparatus is decrypted by using the encryption key and transmitted to a terminal apparatus of a transmission destination. As a protocol for such encryption communication, recently, the IP security protocol (IPsec) which enables encryption communication without depending on applications is widely utilized. The IP security protocol is positioned in the IP network layer, does not require security setting for each application, and can unify security functions. In encryption in the IP security protocol, shared encryption key encryption is used for enabling high-speed communication processing, wherein an encryption key is shared by generating the encryption key and passing it to the counterpart before communication according to an encryption key exchange protocol. The shared encryption key encryption method is a method in which the same encryption key is used in encryption and decryption. Furthermore, in encryption communication, in order to prevent attackers from analyzing the encryption key, validity time is set for the encryption key, and the encryption key is periodically changed. Update of the encryption key when it reaches the validity time is also performed by the encryption key exchange protocol.

FIGS. 1A and 1B are block diagrams of a conventional encryption communication system. In FIGS. 1A and 1B, an encryption communication apparatus 106-1 is disposed in a center site 100, and terminal apparatuses 108-1 to 108-3 are connected to the encryption communication apparatus 106-1 by a LAN or the like. The encryption communication apparatus 106-1 is connected to encryption communication apparatuses 106-2 to 106-4, which are disposed in local sites 102-1 to 102-3, via a network 104 such as a WAN or the like. Encryption key control tables 114-1 to 114-4 are provided in the encryption communication apparatuses 106-1 to 106-4, respectively. Terminal apparatuses 108-4 to 108-6 are connected to the encryption communication apparatuses 106-2 to 106-4 of the local sites 102-1 to 102-3, respectively.

FIG. 2 is a block diagram of a functional configuration realized by executing a program of the encryption communication apparatus 106-1 disposed in the center site 100 of FIGS. 1A and 1B. In FIG. 2, in the encryption communication apparatus 106-1, a frame transmitting and receiving unit 110-1, an encryption key exchange processing unit 112-1, the encryption key control table 114-1, and a validity time control unit 116-1 are provided. The frame transmitting and receiving unit 110-1 transmits and receives the frames (packet data) which pass through the encryption communication apparatus 106-1 and the frames which are issued by the apparatus per se for encryption key exchange. It searches the encryption key control table 114-1 and retrieves encryption keys for frames which pass through the apparatus, encrypts transmitted frames, and decrypts received frames. The encryption key exchange processing unit 112-1 exchanges encryption key information by an advance negotiation (negotiation) with a counterpart apparatus which performs encryption communication in accordance with the encryption key exchange protocol and generates an encryption key. The validity time control unit 116-1 periodically scans the encryption key control table 114-1, and instructs the encryption key exchange processing unit 112-1 to update encryption keys which are close to validity time expiration. The encryption key control table 114-1 records, as shown in FIG. 3A, generation time of encryption keys, validity time, counterpart apparatuses, and encryption keys. In generation of an encryption key, when a frame to be transferred to another encryption communication apparatus is received by the frame transmitting and receiving unit 110-1, the encryption key control table 114-1 is referenced, and an encryption key corresponding to the counterpart apparatus is searched. When the required encryption key is not present, the encryption key exchange processing unit 112-1 is instructed to generate the encryption key. The encryption key exchange processing unit 112-1 negotiates with the counterpart apparatus so as to determine an encryption key exchange protocol, generates an encryption key and record it in the encryption key control table 114-1, encrypts the frame of the encryption key information and transmits it to the counterpart apparatus, and shares the encryption key.

FIGS. 3B to 3D are the encryption key control tables 114-2 to 114-4 of the encryption communication apparatuses 106-2 to 106-4 disposed in the local sites 102-1 to 102-3 of FIGS. 1A and 1B, wherein encryption key information generated by encryption key exchange processes with the encryption communication apparatus 106-1 of the center site 100 is similarly recorded. Note that the generation of the encryption key in the encryption key exchange process may be performed in either the transmitting side or the receiving side, and, in either case, the generating side has to pass the encryption key to the counterpart side in order to share the encryption key. In update of an encryption key, in the system of FIGS. 1A and 1B, the validity time control unit 116-1 provided in the encryption communication apparatus 106-1 of the center site 100 shown in FIG. 2 periodically scans the encryption key control table 114-1, and instructs the encryption key exchange processing unit 112-1 to update the encryption key of which remaining time until validity time is equal to or less than a certain period of time. The encryption key exchange processing unit 112-1 generates the encryption key in a similar manner as first encryption key exchange, records it in the encryption key control table 114-1 so as to update it, encrypts the frame of the encryption key information, transmits it to the counterpart apparatus, and updates the encryption key of the counterpart apparatus at the same time.

However, in such conventional encryption communication system, in the case in which encryption key information of many counterpart apparatuses is recorded in the encryption key control table 114-1 of the encryption communication apparatus 106-1 of the center site so as to control validity time, and the same operation starting time is determined for the plurality of counterpart apparatuses and the same validity period is set so as to start operation, the validity time is close to one another since the encryption key generation time is close to one another; and, when encryption key exchange processes are sequentially started with the encryption communication apparatuses 106-4, 106-2, and 106-3 which have close validity time since the encryption key generation time is close to each other and serve as counterpart apparatuses immediately before validity time, the problem that the load of the encryption communication apparatus 106-1 becomes high, and new encryption keys cannot be generated before the validity time of the old encryption keys is expired is generated. When the new encryption keys cannot be generated until the validity time, communication with the counterpart apparatuses cannot be carried out until new encryption keys are generated after the validity time. In order to solve this problem, there is a method in which validity time of each of the sites is varied by using random numbers in order to prevent concentration of encryption key update. However, since the variation range of the validity time according to the random numbers is suppressed to a certain range, encryption key update with the plurality of counterpart apparatuses is sequentially performed within the time of the variation range, the encryption key update takes time if normal frame encryption communication is performed and the apparatus load is high at this point, and a problem that new encryption keys are not generated before the validity time of the old encryption keys expires may occur.

### SUMMARY OF THE INVENTION

In addition, according to the present invention to provide an encryption communication apparatus which prevents occurrence of an uncommunicatable state due to validity time expiration of encryption keys from occurring by monitoring the apparatus load and the communication volumes with the counterpart apparatuses and dynamically performing encryption key update.

(System)

The present invention provides an encryption communication system. The present invention is an encryption communication system in which a plurality of encryption communication apparatuses to which terminal apparatuses are connected are connected via a network, data received from the terminal apparatus which is a transmission source is encrypted and transmitted to the other encryption communication apparatus, and the data received from the other encryption communication apparatus is decrypted and transmitted to the terminal apparatus which is a transmission destination, characterized in that,

in each of the plurality of encryption communication apparatuses,

a frame transmitting and receiving unit which encrypts and transmits the data for the other encryption communication apparatus by using an encryption key and decrypts the data received from the other encryption communication apparatus by using an encryption key, and

an encryption key exchange processing unit which generates and exchanges the encryption key in accordance with a predetermined encryption key exchange procedure involving advance negotiation with the counterpart apparatus upon initiation of first communication with the other encryption communication apparatus are provided; and,

in at least a part of the plurality of encryption communication apparatuses,

an apparatus load measurement unit which measures apparatus load,

a communication volume measurement unit which measures the volume of communication with each of the encryption communication apparatuses of the counterpart, and

a validity time control unit which sets validity time for the encryption key generated by the encryption key exchange unit, searches an encryption key of which validity time is close, and instructs the encryption key exchange processing unit to update the encryption key by generating an encryption key again, or, in the case in which there is no encryption key of which validity time is close, when the apparatus load is determined to be in a low state, searches an encryption key of the encryption communication apparatus of a counterpart for which the communication volume is small, and instructs the encryption key exchange processing unit to update the encryption key by exchanging the encryption key again

are provided.

Herein, the validity time control unit has an encryption key control table; and encryption key generation date and time, validity time, the counterpart apparatus, the communication volume, and the encryption key are recorded and controlled in the encryption key control table.

As a mode of the encryption communication system, when a plurality of local encryption communication apparatuses are connected to a particular center encryption communication apparatus so as to perform encryption communication, in the center encryption communication apparatus, the frame transmitting and receiving unit, the encryption key exchange processing unit, the apparatus load measurement unit, the communication volume measurement unit, and the validity time control unit are provided; and, in each of the local encryption communication apparatuses, the frame transmitting and receiving unit and the encryption key exchange processing unit are provided.

As another mode of the encryption communication system, when encryption communication is to be performed mutually between the plurality of encryption communication apparatuses, in each of the plurality of encryption communication apparatuses, the frame transmitting and receiving unit, the encryption key exchange processing unit, the apparatus load measurement unit, the communication volume measurement unit, and the validity time control unit are provided.

When first reception connection is received from the other encryption communication apparatus, the encryption key exchange processing unit generates and exchanges the encryption key and instructs the validity time control unit to perform validity time control of the encryption key.

When first transmission connection to the other encryption communication apparatus is achieved, the encryption key exchange processing unit may generate and exchange the encryption key and instruct the validity time control unit to perform validity time control of the encryption key.

In the encryption communication system of the present invention, the apparatus load measurement unit measures CPU load; and the validity time control unit determines encryption key update timing when a mean value of the CPU load during a past predetermined period of time is lower than a predetermined value, searches the encryption communication apparatus of the counterpart having the communication volume which is equal to or less than a predetermined value and minimum, and instructs the encryption key exchange unit to update the encryption key by generating an encryption key again.

The communication volume measurement unit measures a bit rate per unit time (bps) as the communication volume.

The validity time control unit prohibits encryption key update for a predetermined period of time from update of the encryption key.

The encryption key exchange processing unit generates and exchanges the encryption key of a shared key encryption method which uses the same encryption key in encryption and decryption.

(Apparatus)

The present invention provides an encryption communication apparatus. The present invention is an encryption communication apparatus in which data received from a terminal apparatus which is a transmission source is encrypted and transmitted to another encryption communication apparatus, and the data received from the other encryption communication apparatus is decrypted and transmitted to the terminal apparatus which is a transmission destination, characterized by having

a transmitting and receiving unit which encrypts and transmits the data for the other encryption communication apparatus by using an encryption key and decrypts the data received from the other encryption communication apparatus by using an encryption key;

an encryption key exchange processing unit which generates and exchanges the encryption key in accordance with a predetermined encryption key exchange procedure involving advance negotiation with the counterpart apparatus upon initiation of first communication with the other encryption communication apparatus are provided;

an apparatus load measurement unit which measures apparatus load;

a communication volume measurement unit which measures the volume of communication with each of the encryption communication apparatuses of the counterpart; and

a validity time control unit which sets validity time for the encryption key generated by the encryption key exchange unit, searches an encryption key of which validity time is close, and instructs the encryption key exchange processing unit to update the encryption key by generating an encryption key again, or, in the case in which there is no encryption key of which validity time is close, when the apparatus load is determined to be in a low state, searches the encryption communication apparatus of a counterpart for which the communication volume is small, and instructs the encryption key exchange processing unit to update the encryption key by exchanging the encryption key again.

(Method)

The present invention provides an encryption communication method. The present invention is an encryption communication method in which a plurality of encryption communication apparatuses to which terminal apparatuses are connected are connected via a network, data received from the terminal apparatus which is a transmission source is encrypted and transmitted to the other encryption communication apparatus, and the data received from the other encryption communication apparatus is decrypted and transmitted to the terminal apparatus which is a transmission destination, characterized by including

a transmitting and receiving step in which the data for the other encryption communication method is encrypted and transmitted by using an encryption key, and the data received from the other encryption communication apparatus is decrypted by using the encryption key;

an encryption key exchange processing step in which the encryption key is generated and exchanged in accordance with a predetermined encryption key exchange procedure involving advance negotiation with the counterpart apparatus upon initiation of first communication with the other encryption communication apparatus;

an apparatus load measurement step in which apparatus load is measured;

a communication volume measurement step in which the volume of communication with each of the encryption communication apparatuses of the counterpart is measured;

a validity time control step in which validity time is set for the encryption key generated in the encryption key exchange step, an encryption key of which validity time is close is searched, and the encryption key exchange processing step is instructed to update the encryption key by generating an encryption key again, or, in the case in which there is no encryption key of which validity time is close, when the apparatus load is determined to be in a low state, an encryption key of the encryption communication apparatus of a counterpart for which the communication volume is small is searched, and the encryption key exchange processing step is instructed to update the encryption key by exchanging the encryption key again.

(Program)

The present invention provides an encryption communication program. The encryption communication program of the present invention is characterized by causing a computer of an encryption communication apparatus in which a plurality of encryption communication apparatuses to which terminal apparatuses are connected are connected via a network, data received from the terminal apparatus which is a transmission source is encrypted and transmitted to the other encryption communication apparatus, and the data received from the other encryption communication apparatus is decrypted and transmitted to the terminal apparatus which is a transmission destination, to execute

a transmitting and receiving step in which the data for the other encryption communication apparatus is encrypted and transmitted by using an encryption key, and the data received from the other encryption communication apparatus is decrypted by using the encryption key;

an encryption key exchange processing step in which the encryption key is generated and exchanged in accordance with a predetermined encryption key exchange procedure involving advance negotiation with the counterpart apparatus upon initiation of first communication with the other encryption communication apparatus;

an apparatus load measurement step in which apparatus load is measured;

a communication volume measurement step in which the volume of communication with each of the encryption communication apparatuses of the counterpart is measured;

a validity time control step in which validity time is set for the encryption key generated in the encryption key exchange step, an encryption key of which validity time is close is searched, and the encryption key exchange processing step is instructed to update the encryption key by generating an encryption key again, or, in the case in which there is no encryption key of which validity time is close, when the apparatus load is determined to be in a low state, the encryption communication apparatus of a counterpart for which the communication volume is small is searched, and the encryption key exchange processing step is instructed to update the encryption key by exchanging the encryption key again.

(Apparatus)

The present invention is an encryption communication apparatus which is connected to another encryption communication apparatus via a network, is connected to a terminal apparatus, encrypts data received from the terminal apparatus and transmits the data to the other encryption communication apparatus, and decrypts data received from the other encryption communication apparatus and transmits the data to the terminal apparatus, characterized by having

a transmitting and receiving unit which encrypts the data to be transmitted to the other encryption communication apparatus by using an encryption key and transmits the data, and decrypts the data received from the other encryption communication apparatus by using the encryption key;

an encryption key processing unit which generates the encryption key used in data transmission and reception with the other encryption communication apparatus in accordance with an encryption key exchange procedure;

an apparatus load measurement unit which measures the load of the apparatus per se;

a communication volume measurement unit which measures a communication volume of the other encryption communication apparatus; and

a control unit which, when a state in which load is low is determined by the apparatus load measurement unit, searches the other encryption communication apparatus having a small communication volume based on a measurement result of the communication volume measurement unit, and instructs the encryption key exchange processing unit to update the encryption key which is shared with the other encryption communication apparatus.

(Information Processing Apparatus)

The present invention is an information processing apparatus which is connected to another apparatus and transmits/receives information to or from the other apparatus, characterized by having

a transmitting and receiving unit which transmits transmitted information encrypted by an encryption key to the other apparatus and decrypts received information from the other apparatus by the encryption key;

an apparatus load measurement unit which measures load of the apparatus per se; and

a control unit which, when the state in which the load is low is determined by the apparatus load measurement unit, searches the other apparatus having a small communication volume and updates the encryption key used in information transmission/reception to or from the other apparatus.

Herein, the information processing apparatus is connected to a plurality of the other apparatuses; and the encryption key processing unit generates different encryption keys respectively for the plurality of other apparatuses.

According to the present invention, in addition to control of encryption keys for which validity time is set, during the validity time period of the encryption keys, the encryption key of a counterpart apparatus having a small communication volume in the state in which CPU load is low is searched, and encryption key update is performed; therefore, even when operation of a plurality of encryption communication apparatuses is started at the same time, and the same validity time is set so as to start control of encryption key update, a temporary uncommunicatable state in which the encryption keys cannot be updated within the validity time period since encryption key update for the plurality of counterpart apparatuses is concentrated in the vicinity of the validity time can be reliably avoided, and safety of encryption communication can be enhanced. Update timing of the encryption keys with the plurality of counterpart apparatuses is dynamically varied in accordance with the CPU load of the apparatus per se and the volume of communication with the counterpart apparatuses; therefore, even when the validity time is close to one another immediately after operation initiation, when the encryption keys are dynamically updated during the validity time period, the validity time after update is mutually shifted and is dispersed in terms of time, and the validity time can be reliably dispersed compared with the conventional method in which random numbers are used. The above and other objects, features, and advantages of the present invention will become more apparent from the following detailed description with reference to the drawings.

### BRIEF DESCRIPTION OF THE DRAWINGS

FIGS. 1A and 1B are block diagrams of a conventional encryption communication system;

FIG. 2 is a block diagram of the functional configuration of the encryption communication apparatus of FIGS. 1A and 1B;

FIGS. 3A to 3D are explanatory diagrams of encryption key control tables provided in the encryption communication apparatuses of the conventional system of FIG. 13;

FIGS. 4A and 4B are block diagrams showing an embodiment of an encryption communication system according to the present invention, wherein time of validity is centrally controlled by a center site;

FIG. 5 is a block diagram of a functional configuration showing an embodiment of the encryption communication apparatus according to the present invention which is disposed in the center site of FIGS. 4A and 4B;

FIG. 6 is a block diagram of a functional configuration showing an embodiment of an encryption communication apparatus according to the present invention which is disposed in a local site of FIGS. 4A and 4B;

FIGS. 7A to 7D are explanatory diagrams of encryption key control tables provided in the encryption communication apparatuses of the embodiment of FIGS. 4A and 4B;

FIG. 8 is a block diagram of a hardware environment of a computer which executes a program which realizes functions of the encryption communication apparatus of the present embodiment;

FIGS. 9A and 9B are flow charts of an encryption communication process in the center site of FIGS. 4A and 4B;

FIGS. 10A and 10B are flow charts of an encryption communication process in a local site of FIGS. 4A and 4B;

FIG. 11 is a flow chart showing details of the validity time control process in step S13 of FIGS. 9A and 9B;

FIG. 12 is a flow chart showing details of the validity time control process in step S13 of FIGS. 9A and 9B in the case in which encryption key update prohibited period is set;

FIG. 13 is a block diagram showing another embodiment of an encryption communication system according to the present invention, wherein validity time is controlled in each site;

FIGS. 14A to 14D are explanatory diagrams of encryption key control tables provided in the encryption communication apparatuses of the embodiment of FIG. 13;

FIGS. 15A and 15B are flow charts of an encryption communication process in a center site of FIG. 13; and

FIG. 16 is a flow chart showing details of the validity time control process in step S13 of FIGS. 15A and 15B.

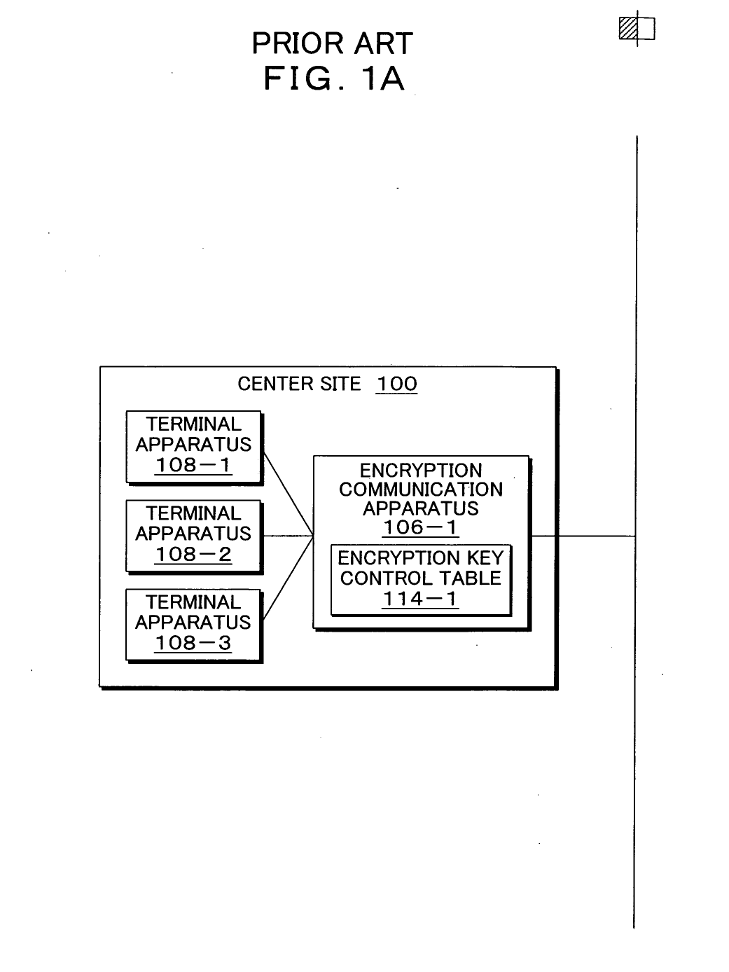

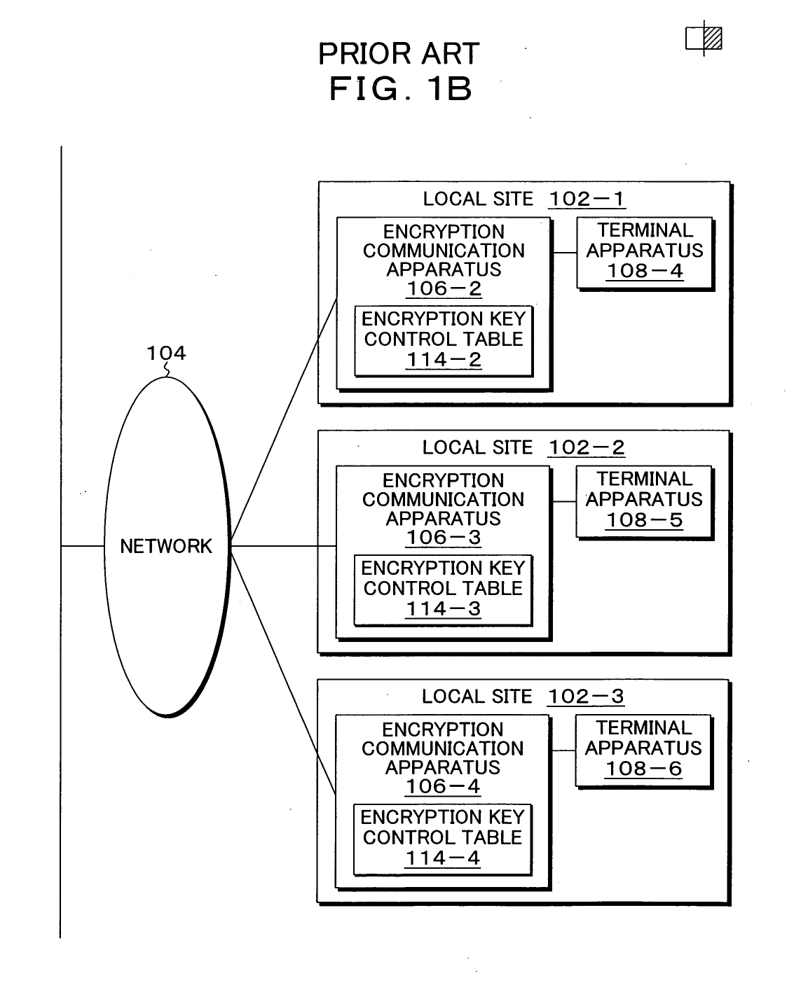

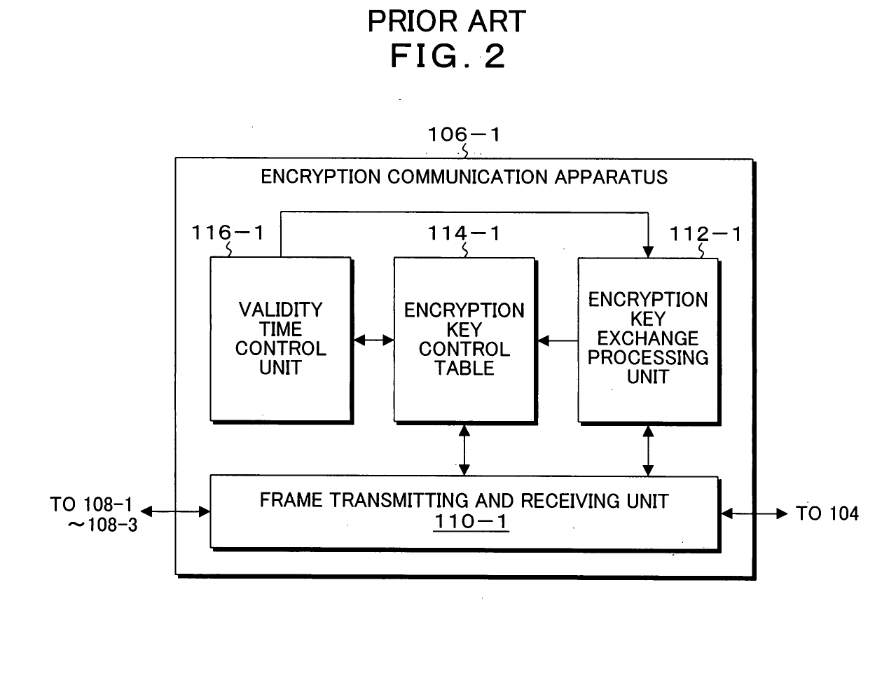

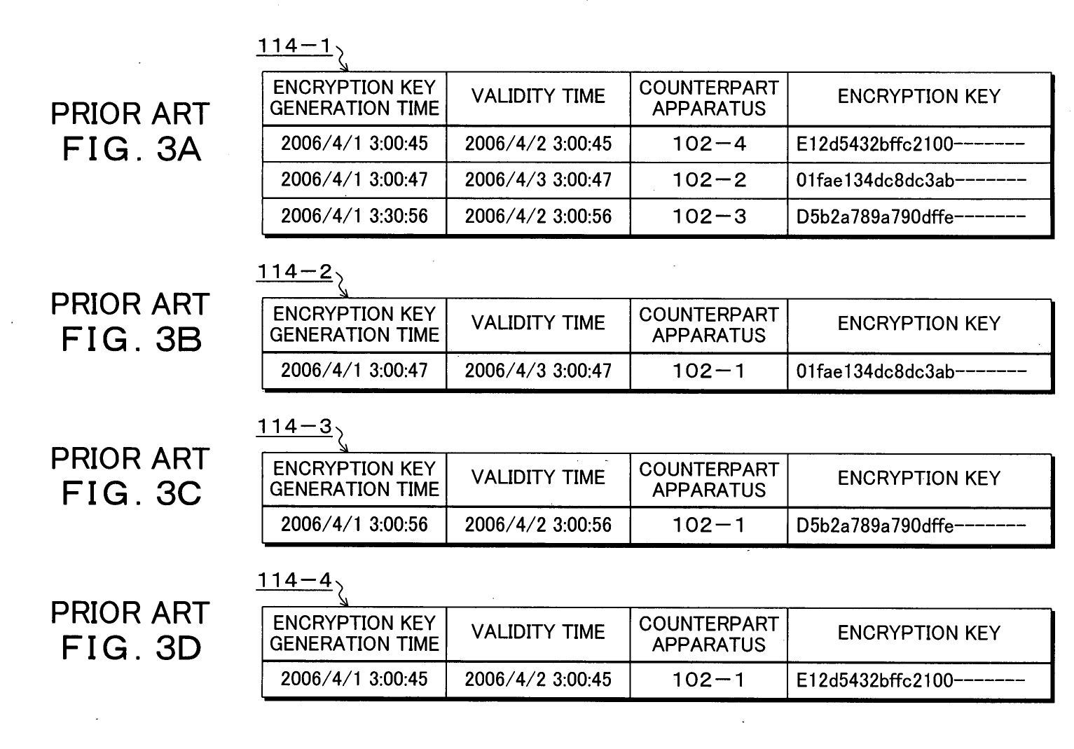

### DETAILED DESCRIPTION OF THE PREFERRED EMBODIMENTS

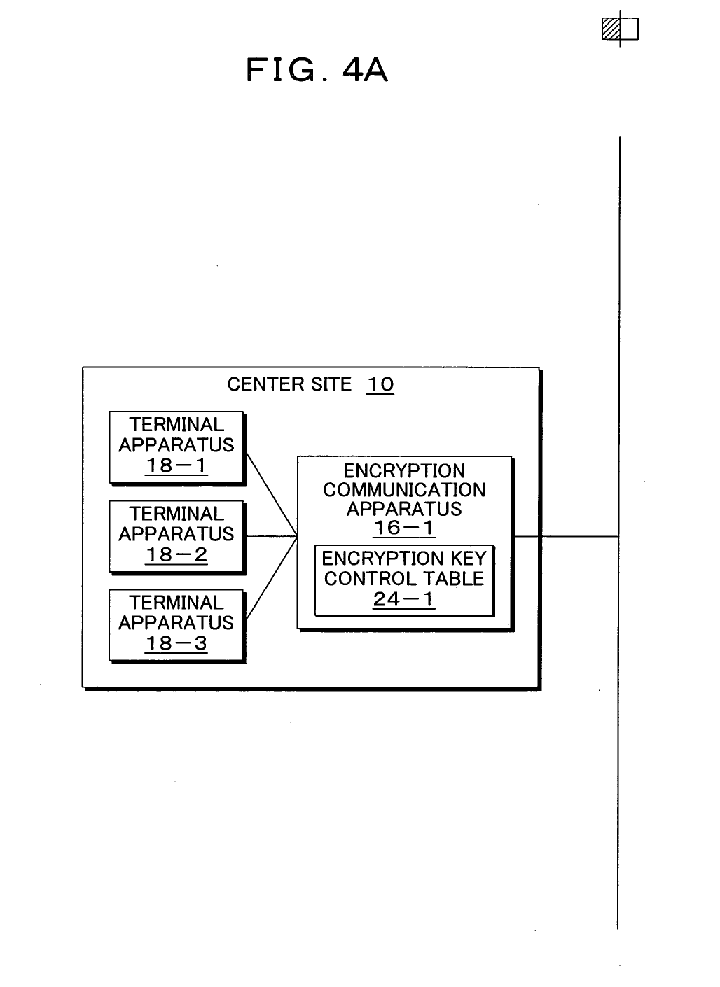

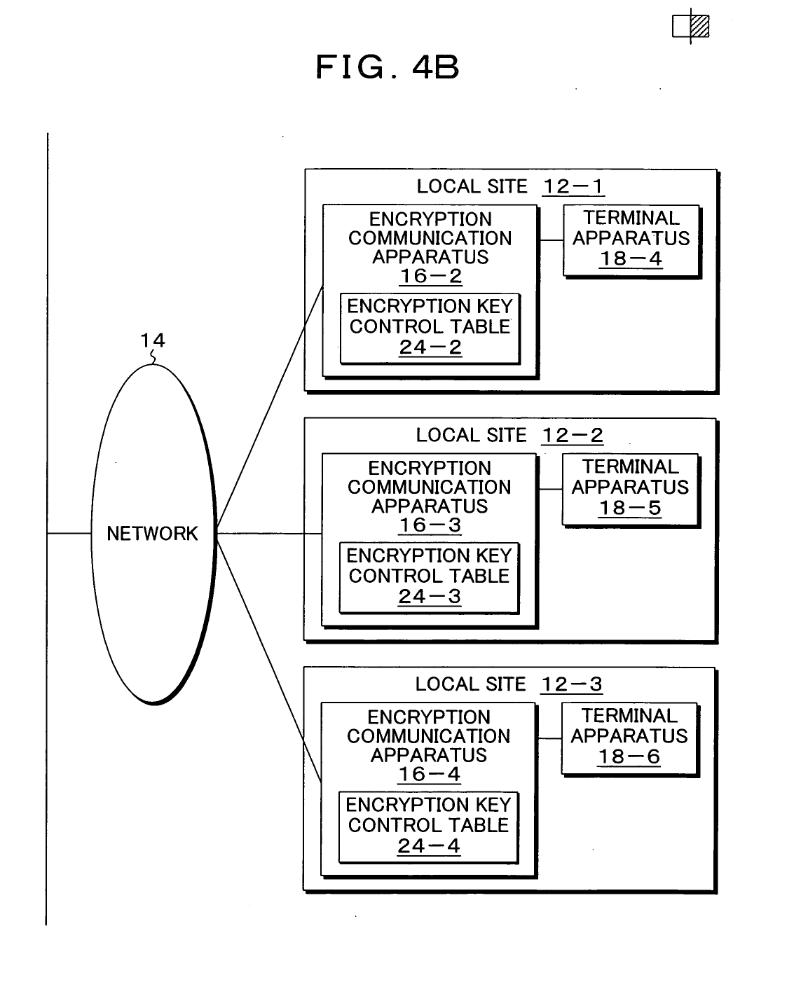

FIGS. 4A and 4B are block diagrams showing an embodiment of an encryption communication system according to the present invention, and this embodiment is characterized in that validity time of encryption keys are centrally controlled in a center site. In FIGS. 4A and 4B, in the encryption communication system of the present embodiment, local sites 12-1, 12-2, and 12-3 are connected to the center site 10 via a network such as a WAN. In the center site 10 and the local sites 12-1 to 12-3, encryption communication apparatuses 16-1, 16-2, 16-3, and 16-4 according to the present invention are provided, respectively, and they have encryption key control tables 24-1, 24-2, 24-3, and 24-4, respectively. To the encryption communication apparatus 16-1 of the center site 10, terminal apparatuses 18-1, 18-2, and 18-3 are connected by a LAN or the like. Also, in the local sites 12-1 to 12-3, terminal apparatuses 18-4 to 18-6 are connected to the respective encryption communication apparatuses 16-2 to 16-4 by LANs or the like. An example of the encryption communication system in which the center site 10 and the local sites 12-1 to 12-3 are connected by a network 14 is the case in which the center site 10 is, for example, a central office of a company, and the local sites 12-1 to 12-3 are branch offices thereof. In the encryption communication system of the present embodiment, in the encryption communication apparatus 16-1 of the center site 10, validity time is set for encryption keys used in encryption communication with the local sites 12-1 to 12-3, and the validity time of the encryption keys is controlled.

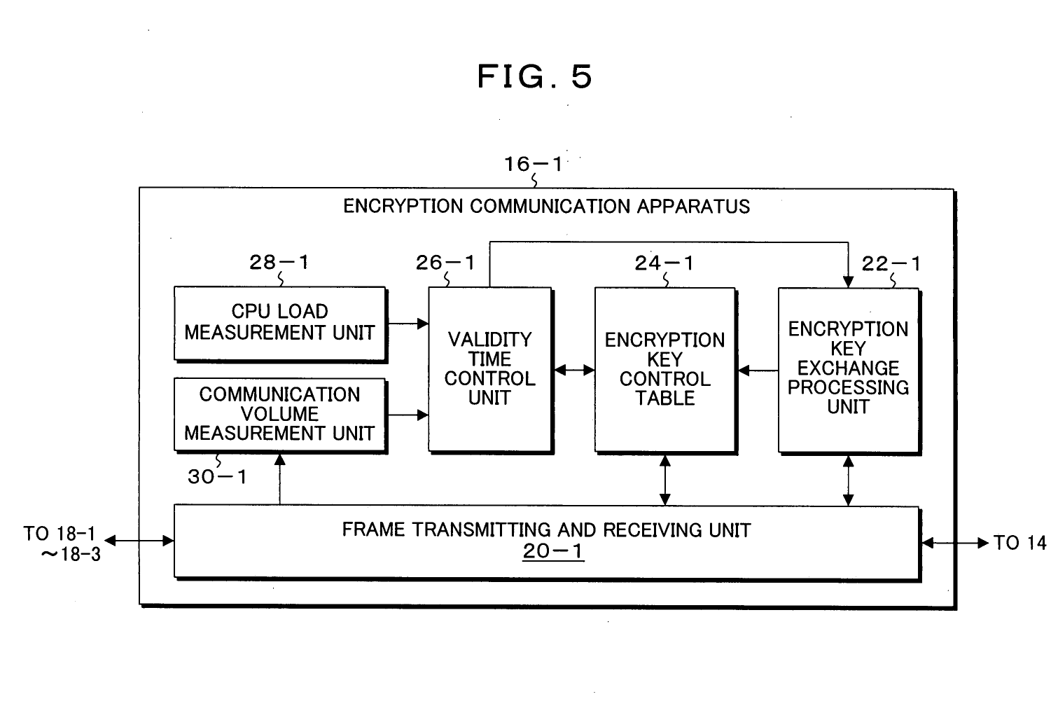

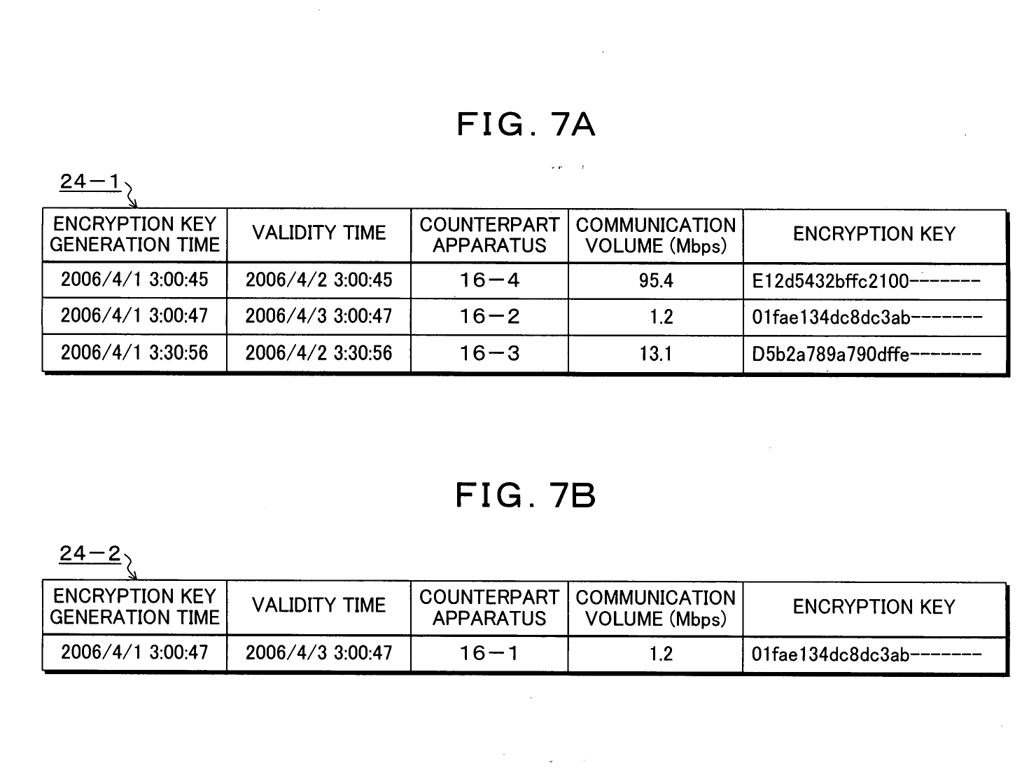

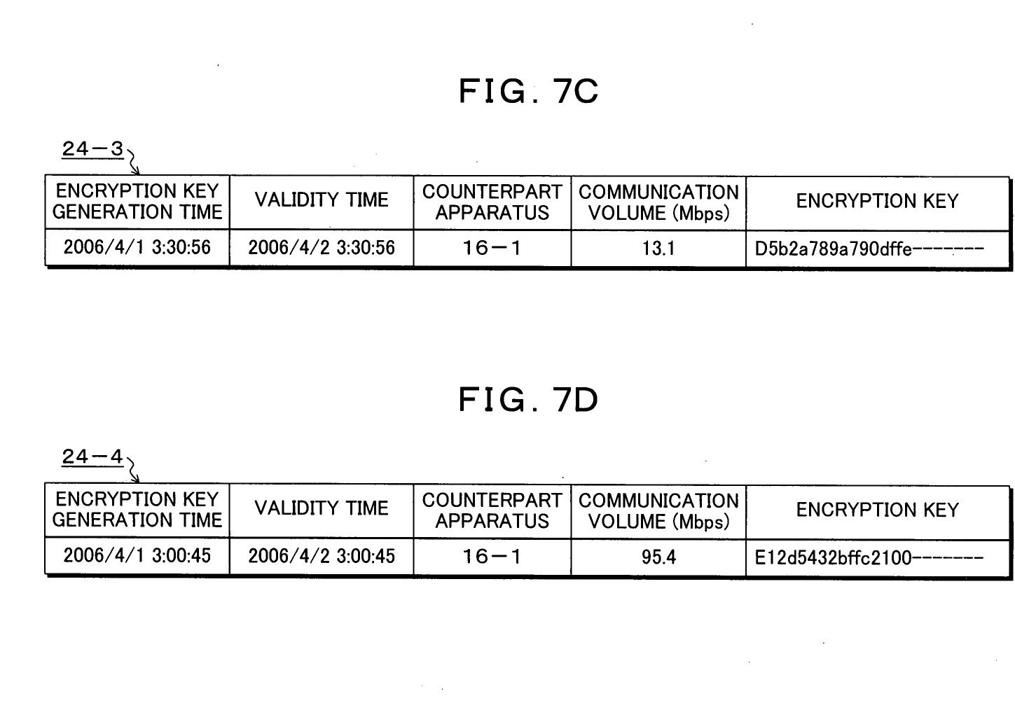

FIG. 5 is a block diagram of a functional configuration showing an embodiment of the encryption communication apparatus 16-1 according to the present invention which is disposed in the center site of FIGS. 4A and 4B, and this functional configuration is a function realized by executing an encryption communication program of the present embodiment by a computer which constitutes the encryption communication apparatus 16-1. In FIG. 5, in the encryption communication apparatus 16-1 of the center site, a frame transmitting and receiving unit 20-1, an encryption key exchange processing unit 22-1, an encryption key control table 24-1, a validity time control unit 26-1, a CPU load measurement unit 28-1, and a communication volume measurement unit 30-1 are provided. The frame transmitting and receiving unit 20-1 encrypts frames (packet data) which pass through the encryption communication apparatus 16-1, specifically, transmitted frames from the terminal apparatuses 18-1 to 18-3 of FIGS. 4A and 4B by using encryption keys, decrypts received frames from the encryption communication apparatuses 16-2 to 16-4 of the other local sites 12-1 to 12-3 received via the network 14 by using encryption keys, and outputs the decrypted frames to the terminal apparatuses 18-1 to 18-3 side. The encryption key exchange processing unit 22-1 generates encryption keys in accordance with a predetermined encryption key exchange protocol which involves advance negotiation (negotiation) upon first communication initiation with another encryption communication apparatus, records them in the encryption key control table 24-1 of the apparatus per se, and shares the encryption keys by passing them to counterpart apparatuses. As an encryption communication method of the present embodiment, for example, the IPSec (IP security protocol) which is a standard of an encryption communication method of which standardization is promoted by IETF is used. The IPSec employs a shared encryption key encryption method in which the same encryption key is used in encryption and decryption as an encryption method; this is used since, when it is compared with a public encryption key encryption method which uses a public encryption key and a secret encryption key, the processing speed of encryption and decryption is higher in the shared encryption key encryption method. Although encryption algorithms used in the IPSec include a plurality of encryption algorithms, DES (Data Encryption Standard) is required to be implemented. In the IPSec, the encryption algorithms and the encryption keys actually used upon encryption communication are dynamically determined by negotiation (advance negotiation) with the counterpart apparatus immediately before initiation of the communication and exchanged. In other words, encryption algorithms which can be mutually used are presented in the process of negotiation, and the encryption algorithms which can be utilized by both of them are determined. In this case, even when there is a difference between the encryption algorithms of both of them, at least agreement according to DES can be made. When the encryption algorithms to be used in encryption communication are determined, encryption keys to be used by the determined encryption algorithms are subsequently exchanged. This exchange of the encryption keys are executed by the encryption key exchange processing unit 22-1. As the encryption key exchange protocol of the encryption key exchange processing unit 22-1, in the case of the IPSec, IKE (Internet Key Exchange) is specified. The encryption key exchange protocol IKE comprises processes of two stages, and the encryption algorithm which is to be used merely for encryption key exchange is determined in a first stage. In a next second stage, encryption communication limited to the encryption key exchange protocol IKE is enabled, negotiation for encryption communication according to the IPSec is started, an encryption algorithm is determined, and an encryption key is generated and exchanged. The generation and exchange of the encryption key according to the encryption key exchange protocol IKE may be performed in the transmitting side or the receiving side of two encryption communication apparatuses which perform encryption communication. In either case, when an encryption key is generated, the encryption key is passed to the counterpart apparatus so as to share it. In the encryption key control table 24-1, encryption keys generated by the encryption key exchange processing unit 22-1 and shared with the counterpart apparatuses are recorded, and validity time is set so as to control them. The encryption key control table 24-1 has the contents of, for example, FIG. 7A. The encryption key control table 24-1 of FIG. 7A records and controls encryption key generation time, validity time, the counterpart apparatuses, communication volumes, and encryption keys.

Corresponding to the encryption key control table 24-1 provided in the encryption communication apparatus 16-1 of the center site 10 of FIG. 7A, the contents of the encryption key control tables 24-2, 24-3, and 24-4 provided in the encryption communication apparatuses 16-2 to 16-4 of the local sites 12-1 to 12-3 which are counterpart apparatuses are as shown in FIGS. 7B, 7C, and 7D. For example, in the control record of a first row of the encryption key control table 24-1 in the center site 10 of FIG. 7A, the counterpart apparatus is the encryption communication apparatus 16-4 of the local site 12-3, the encryption key generation time is “2006/4/1 3:00:45”, and the validity time is “2006/4/2 3:00:45” since the validity time period is set to 24 hours in this case. Note that, as the validity time period of an encryption key, 8 hours or 24 hours can be generally set, and either one of them is selected and set in accordance with needs. On the other hand, in the encryption control table 24-4 of FIG. 7D of the encryption communication apparatus 16-4 which is the counterpart apparatus of this control record, the encryption generation time and the validity time is same as the control record of the first row of FIG. 7A, and the counterpart apparatus is the encryption communication apparatus 16-1 of the center site. In a second row and a third row of the encryption control table 24-1 in the center site 10 of FIG. 7A, the counterpart apparatuses are the encryption communication apparatus 16-2 of the local site 12-1 and the encryption communication apparatus 16-3 of the local site 12-2; and the encryption key generation time is approximately same as the control record of the first row, wherein it is 47 seconds in the second row which is 2 seconds after that of the first row which is 45 seconds and approximately the same time and it is 56 seconds in the third row which is 11 seconds thereafter, and the encryption keys are generated approximately at the same time. Specifically, in the encryption communication system of FIGS. 4A and 4B, for example upon operation initiation of the system, at operation initiation time, which is determined in advance, first frame transmission is performed from the terminal apparatuses 18-4, 18-5, and 18-6 provided in the local sites 12-1 to 12-3 to, for example, the terminal apparatus 18-1 of the center site 10. Therefore, among the encryption communication apparatuses 16-2, 16-3, and 16-4 provided in the local sites 12-1 to 12-3, an encryption key exchange process is started in the apparatus that first received the frame transmission from the terminal apparatus side, and generation of an encryption key and sharing of the encryption key by exchange is performed by negotiation with the encryption communication apparatus 16-1 of the center site 10 according to the encryption key exchange protocol IKE. As a matter of course, as another operation mode in the encryption communication system, at operation time, which is determined in advance, first frame transmission may be performed from the terminal apparatuses 18-1 to 18-3 of the center site to the terminal apparatuses 18-4, 18-5, and 18-6 in the local site 12-1, 12-2, and 12-3 side, and encryption communication may be started by generating encryption keys in the encryption key exchange processing unit in the encryption communication apparatus 16-1 side and distributing them.

Referring again to FIG. 5, the validity time control unit 26-1 sets validity time when an encryption key is recorded in the encryption key control table 24-1 and controls the set validity time as shown in FIG. 7A. More specifically, the validity time control unit 26-1 searches the encryption key control table 24-1 and instructs the encryption key exchange processing unit 22-1 to update an encryption key if the encryption key of which remaining time with respect to validity time is equal to or less than predetermined time, which is determined in advance. The encryption key exchange processing unit 22-1, which has received the update of the encryption key, generates and exchange an encryption key according to the encryption key exchange protocol, which is same as that upon communication initiation, thereby updating the encryption key of the apparatus per se and the counterpart apparatus. Herein, as the predetermined remaining time until validity time at which update of the encryption key is instructed by the validity time control unit 26-1, time that is sufficient for completing the update by generation/exchange of the encryption key according to a control exchange protocol before expiration is set. In addition to such update of the encryption key using the validity time, in the present embodiment, even when there is no encryption key that is close to validity time in the validity time control unit 26-1, CPU load which is the apparatus load of the encryption communication apparatus 16-1 is measured; and, when the state in which the mean value of the CPU load during a past predetermined period of time is equal to or less than a threshold value is determined, an encryption key for the encryption communication apparatus of the counterpart having a small communication volume wherein the communication volume is equal to or less than a predetermined value is searched for, and the encryption key exchange processing unit 22-1 is instructed to update the encryption key. Therefore, the CPU load measurement unit 28-1 and the communication volume measurement unit 30-1 are provided with respect to the validity time control unit 26-1. The CPU load measurement unit 28-1 measures and outputs the load of a CPU which executes a program of the encryption communication apparatus 16-1. The communication volume measurement unit 30-1 measures the communication volume of encryption communication by the frame transmitting and receiving unit 20-1, specifically, bit rate (bps) and outputs that to the validity time control unit 26-1.

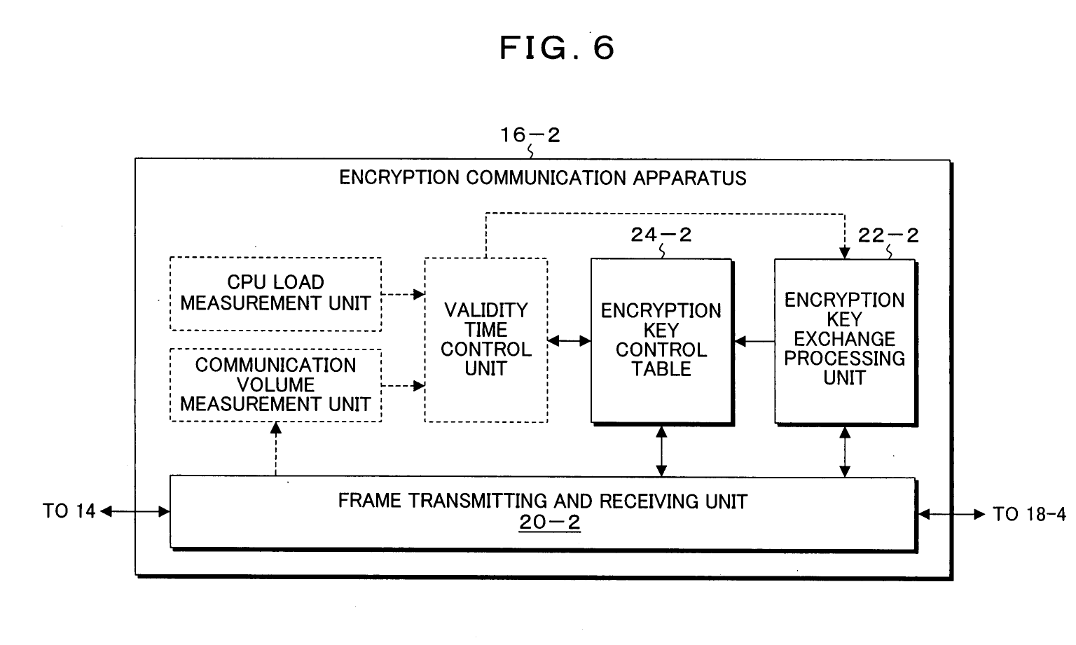

FIG. 6 is a block diagram of a functional configuration showing the encryption communication apparatus 16-2 of the local site 12-1 as an embodiment of the encryption communication apparatuses according to the present invention disposed in the local sites 12-1 to 12-3 of FIGS. 4A and 4B. The encryption communication apparatus 16-2 which is installed in the local site of FIG. 6 has a frame transmitting and receiving unit 20-2, an encryption key exchange processing unit 22-2, and the encryption key control table 24-2; however, since validity time control of encryption keys is performed merely in the encryption communication apparatus 16-1 of the center site in the embodiment of FIGS. 4A and 4B, the functions corresponding to the validity time control unit 26-1, the CPU load measurement unit 28-1, and the communication volume measurement unit 30-1 provided in the encryption communication apparatus 16-1 of the center site of FIG. 5 are invalidated and shown by dotted lines.

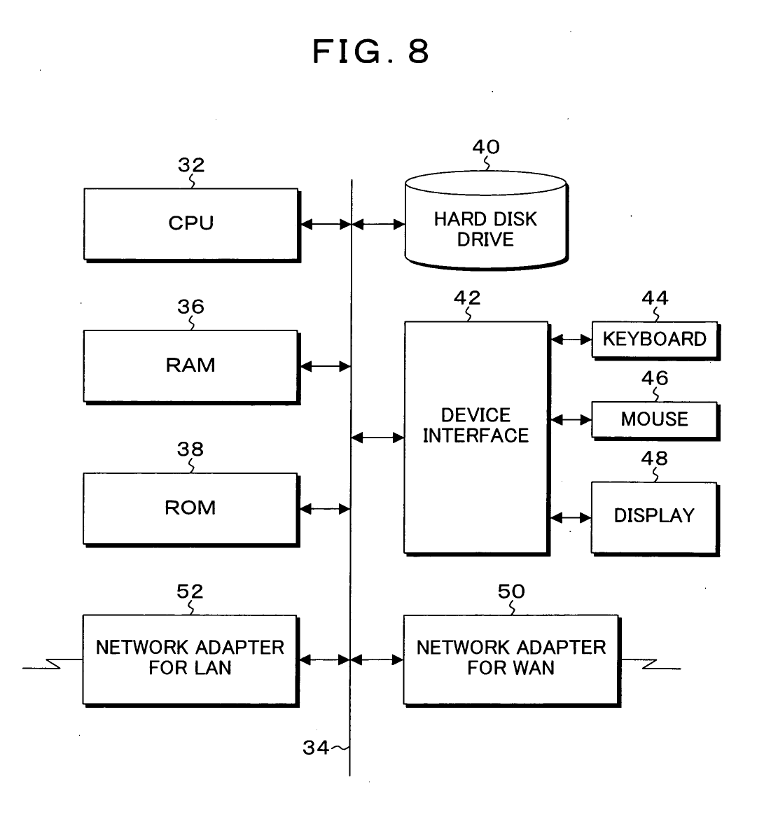

FIG. 8 is a block diagram of a hardware environment of a computer which executes the encryption communication program of the present embodiment. In FIG. 8, the computer which realizes an encryption communication apparatus has a CPU 32; and, to a bus 34 of the CPU 32, a RAM 36, a ROM 38, a hard disk drive 40, a device interface 42 connecting a keyboard 44, a mouse 46, and a display 48, a network adapter 50 for WAN which connects to an outside network, and a network adapter 52 for LAN which connects to inside terminal apparatuses are connected. In the hard disk drive 40, the program for executing encryption communication according to the present invention is stored; and, when the computer is started up, an OS is read and deployed to the RAM 36 by boot-up, and then, the encryption communication program of the present invention serving as an application program is read and deployed to the RAM 36 and executed by the CPU 32.

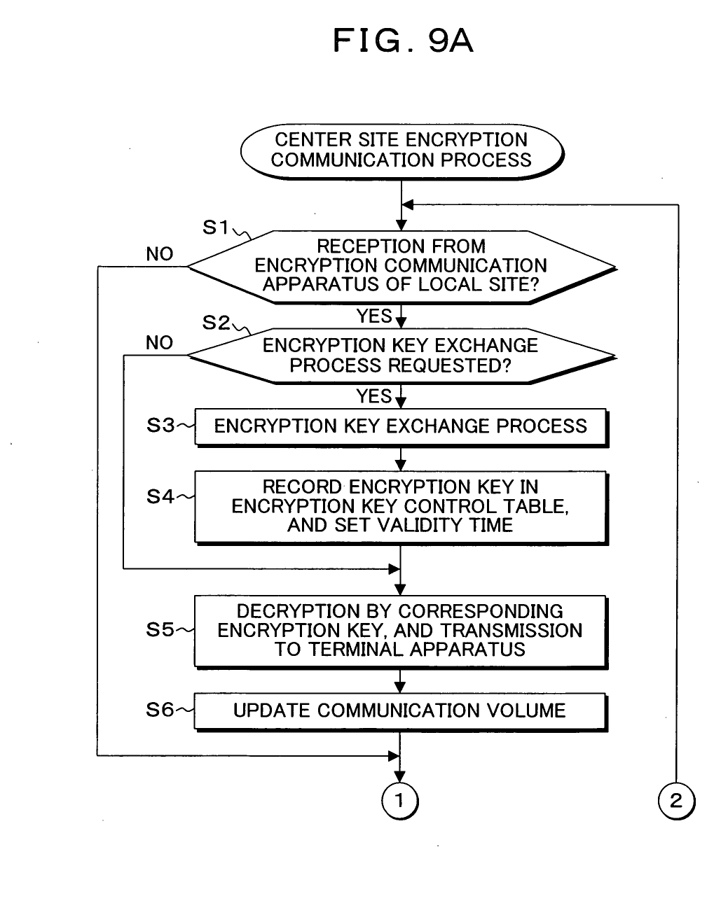

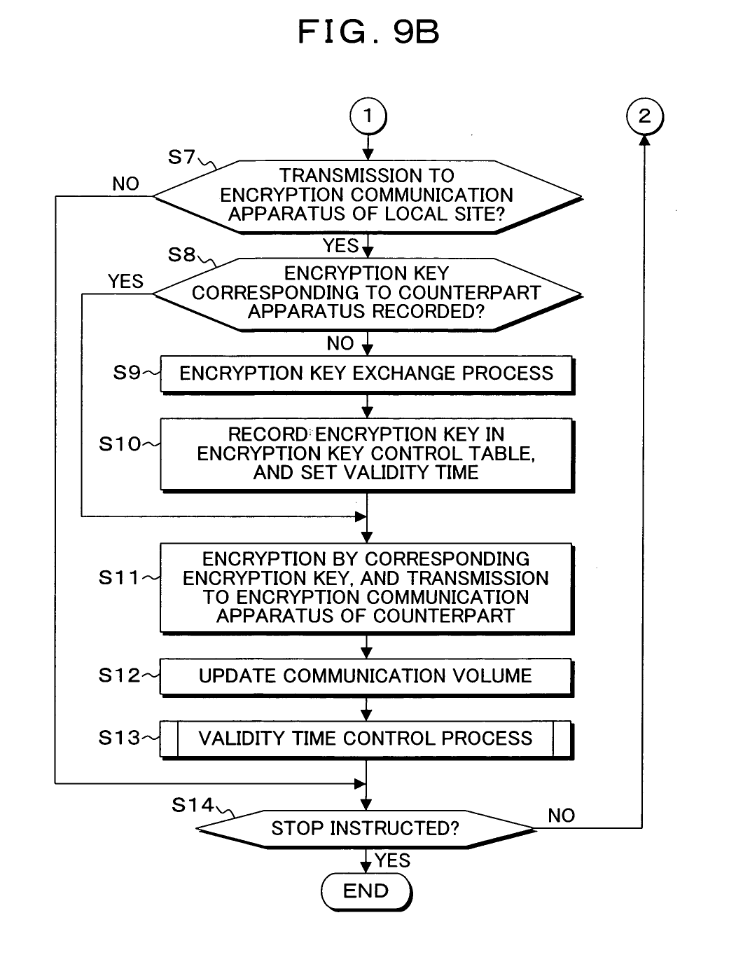

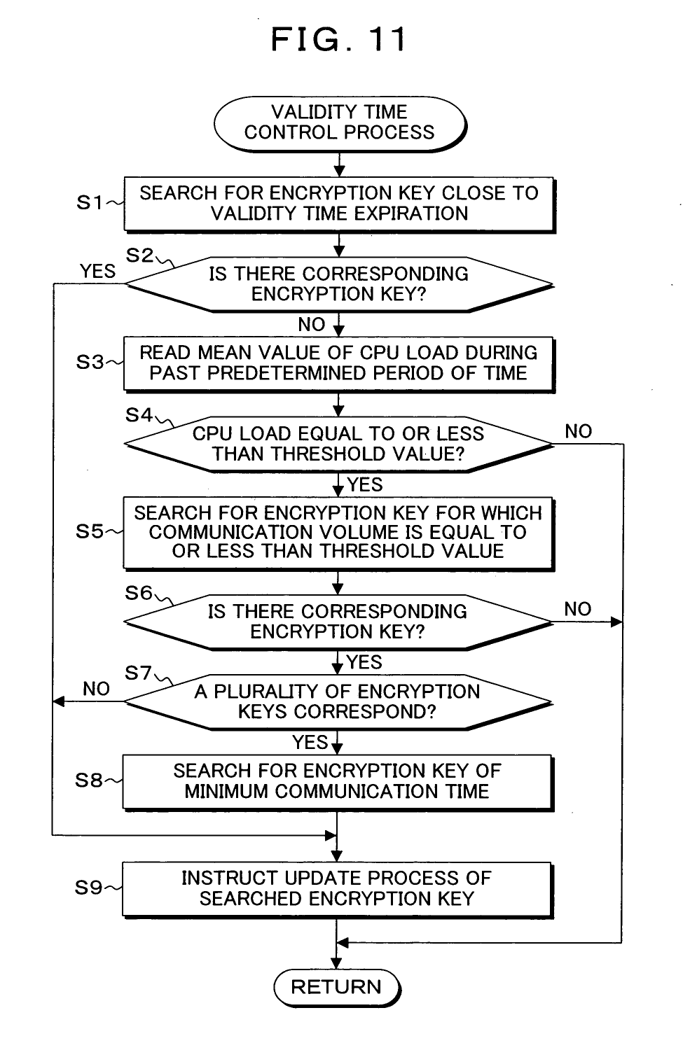

FIGS. 9A and 9B are flow charts of an encryption communication process by the encryption communication apparatus 16-1 provided in the center site 10 of FIGS. 4A and 4B, and the procedure of this flow chart is the contents of the encryption communication program of the encryption communication apparatus 16-1 of the center site which realizes the functional configuration shown in FIG. 5. In FIGS. 9A and 9B, in the center site encryption communication process, at the beginning, presence of reception from the encryption communication apparatuses of the local sites associated with operation initiation is checked in step S1. In the encryption communication system of FIGS. 4A and 4B, since frame transmission from the local sites to the center site is performed upon operation initiation, an encryption key exchange process is started upon communication initiation which is associated with the frame transmission, and communication connection by negotiation which is associated with the encryption key exchange process is received in step S1. Subsequently, if it is an encryption key exchange process request or not is checked in step S2; and, if it is an encryption key exchange process request, the process proceeds to step S3 in which an encryption key exchange process is executed. In the encryption key exchange process, generation and exchange of an encryption key according to the encryption key exchange protocol IKE on the already described encryption algorithm IPSec is performed, thereby sharing the encryption key between the encryption communication apparatus 16-1 of the center site and the counterpart apparatus in the local site side. Subsequently, in step S4, the encryption key generated in the encryption key exchange process is recorded in the encryption key control table 24-1, and, as shown in FIG. 7A, validity time which has, for example, 24 hours of validity time period with respect to the encryption key generation time is set. On the other hand, if the received frame from the local site is not an encryption key exchange process request in step S2, the process proceeds to step S5 in which the encryption key control table 24-1 is searched to obtain an encryption key corresponding to the counterpart apparatus, and the received frame is decrypted by using the obtained encryption key and transmitted to the terminal apparatus of the transmission destination. Subsequently, in step S6, the communication volume in the frame communication is measured, and the value of the communication volume is updated as shown in the encryption key control table 24-1 of FIG. 7A. Meanwhile, if it is not a reception from an encryption communication apparatus of a local site in step S1, the step proceeds to step S7 in which whether it is a transmission to an encryption communication apparatus of a local site or not is checked. At this point, when a transmitted frame from the terminal apparatus side of the transmission source is received, the process proceeds to step S8 in which the encryption key control table 24-1 is searched to search for an encryption key for the counterpart apparatus, and presence of the record is checked. If the encryption key is not recorded, the process proceeds to step S9 in which an encryption key exchange process is executed to generate an encryption key and exchange it with the counterpart apparatus; and, in step S10, the generated encryption key is recorded in the encryption key control table, and validity time is set. If record of the encryption key for the counterpart apparatus is determined in step S8, the process proceeds to step S11 in which the transmitted frame is encrypted by the corresponding encryption key and transmitted to the encryption communication apparatus of the counterpart. Then, in step S12, the communication volume caused by the transmitted frame is measured, and the communication volume of the encryption key control table 24-1 of FIG. 7A is updated. Subsequently, a validity time control process is executed in step S13, details thereof are as shown in the flow chart of FIG. 11. Such processes of steps S1 to S13 are repeated until there is a stop instruction in step S14.

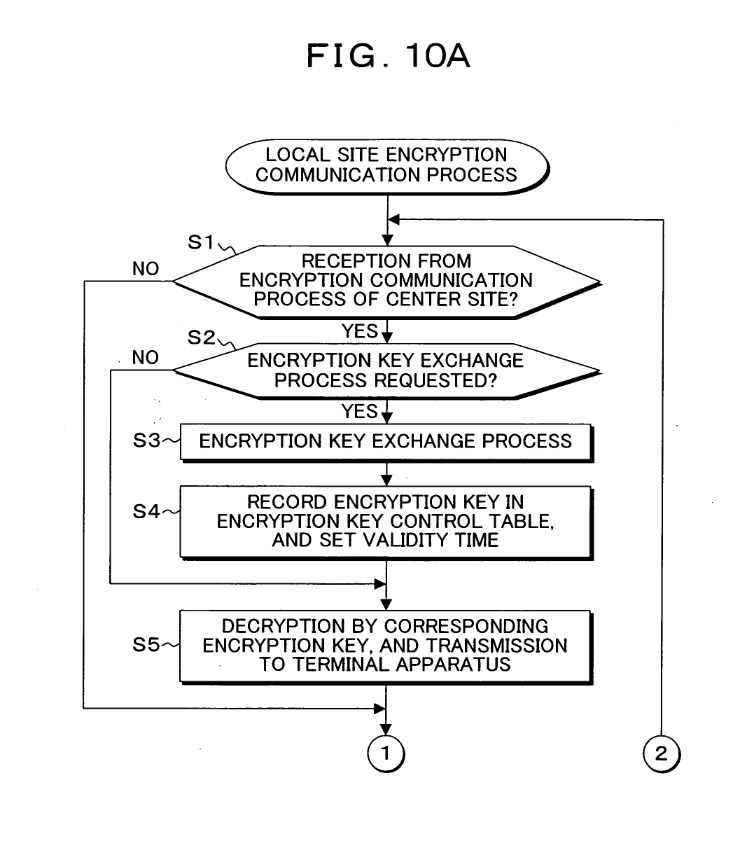

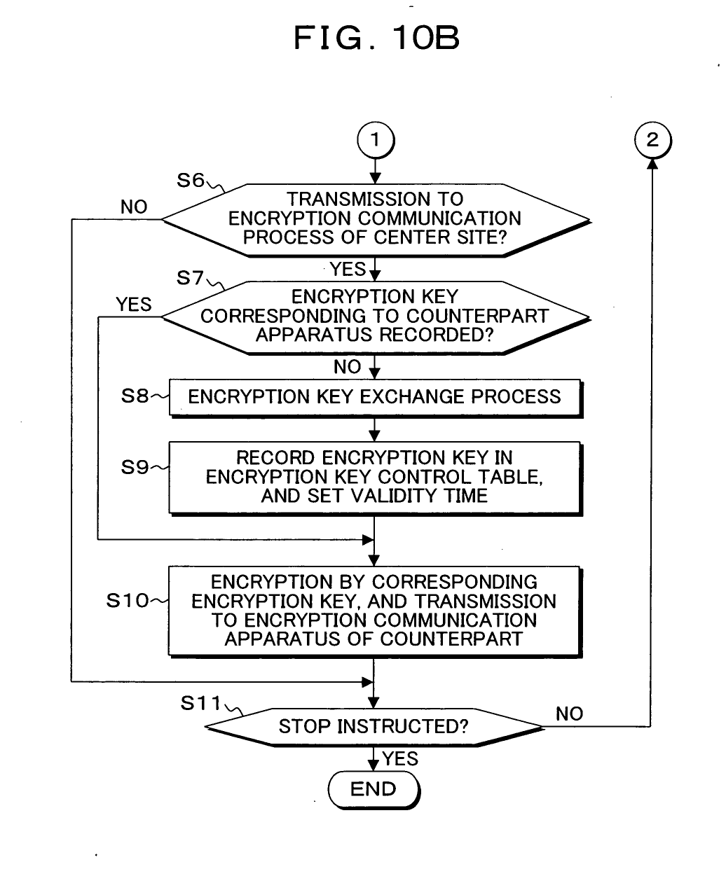

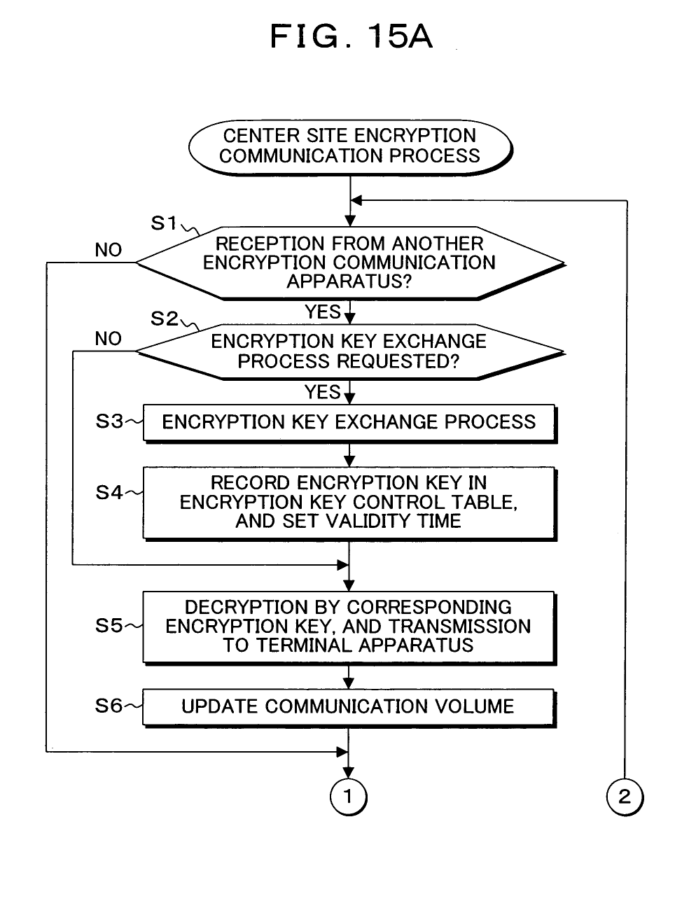

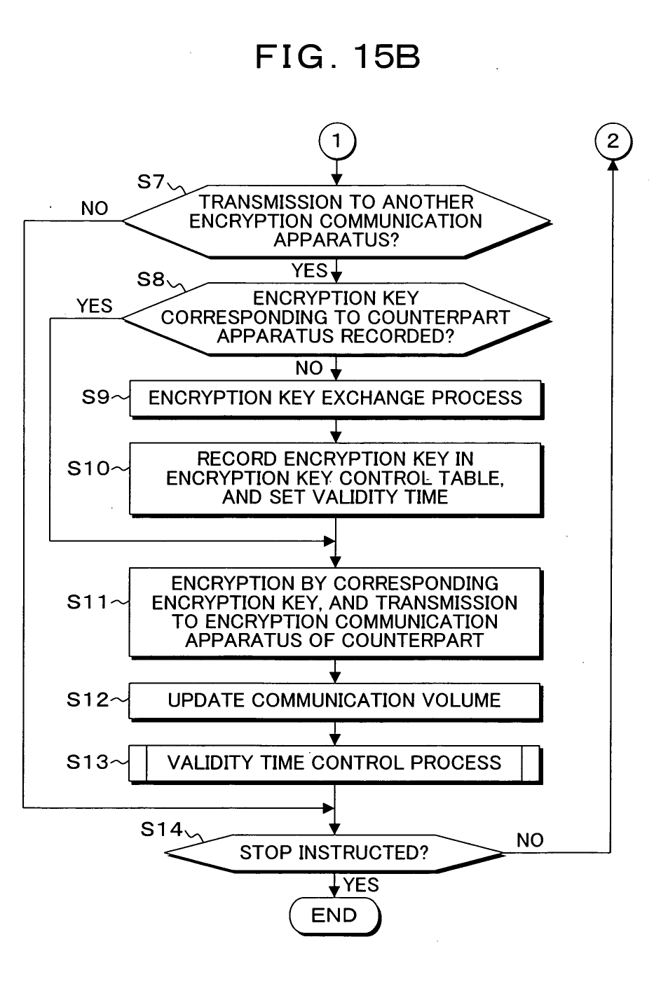

FIGS. 10A and 10B are flow charts of a local site communication process performed in each of the encryption communication apparatuses 16-2, 16-3, and 16-4 of the local sites of FIGS. 4A and 4B and shows the processing contents of a program which realizes the functional configuration of the encryption communication apparatus 16-2 of the local site shown in FIG. 6. In FIGS. 10A and 10B, in the encryption communication process of the local site, when reception from the encryption communication apparatus 16-1 of the center site is determined in step S1, the process proceeds to step S2; when the reception is determined to be an encryption key exchange request therein, an encryption key exchange process is executed in step S3; and, in step S4, a generated encryption key is recorded in the encryption key control table of the apparatus per se, and validity time is set. Herein, since operation is initiated by frame transmission from the local sites 12-1 to 12-3 side in the encryption communication system of FIGS. 4A and 4B, the processes of steps S3 and S4 associated with an encryption key exchange request from the center site side are skipped. If reception of an encrypted frame from the encryption communication apparatus of the center side is determined during operation in step S1, it is determined not to be an encryption key exchange request in step S2, and the process proceeds to step S5 in which the received frame is decrypted by a corresponding encryption key and transmitted to the terminal apparatus of the transmission destination. If a transmitted frame from a terminal apparatus connected to the apparatus per se to the encryption communication apparatus 16-1 of the center site is determined in step S6, the process proceeds to step S7 in which the encryption key control table of the apparatus per se is searched to check the presence of record of the encryption key. Herein, upon operation initiation, since frame transmission is performed from the local sites 12-1 to 12-3 side to the center site 10, record of the encryption key for the counterpart apparatus cannot be obtained even when the encryption key control table is searched upon operation initiation in step S7; in this case, the process proceeds to step S8 in which an encryption key exchange process is executed, for example, an encryption key is generated in the local site side, and it is passed to the center site side so as to share it. Subsequently, in step S9, the generated encryption key is recorded in the encryption key control table, and validity time is set. When frame transmission to the center site is determined in step S6 in the state in which recording of the encryption key is finished after operation initiation, there is a record of the encryption key for the counterpart apparatus in step S7; therefore, the process proceeds to step S10 in which the transmitted frame is encrypted by the corresponding encryption key and transmitted to the encryption communication apparatus 16-1 of the center site which serves as the counterpart. Such processes of steps S1 to S10 are repeated until there is a stop instruction in step S11. In the local site encryption communication process of FIGS. 10A and 10B, since control of the validity time of recorded encryption keys recorded in the encryption key control tables are performed in the center site side, the communication volume update of steps S6 and S12 and the validity time control process of step S13 in the encryption communication process in the center site of FIGS. 15A and 15B are eliminated.

FIG. 11 is a flow chart showing details of the validity time control process in the center site in step S13 of FIGS. 9A and 9B. In FIG. 11, in the validity time control process, the validity time control unit 26-1 of FIG. 5 scans the encryption key control table 24-1 and searches whether there is an encryption key close to validity time expiration. Specifically, an encryption key of which remaining time with respect to validity time is equal to or less than predetermined time is searched as the encryption key which is close to validity time expiration. When a corresponding encryption key which is close to validity time is determined in step S2 through this search, the process proceeds to step S9 in which the encryption key exchange processing unit 22-1 is instructed to perform an update process of the searched encryption key. Consequently, the encryption key exchange processing unit 22-1 performs generation and exchange of an encryption key through negotiation according to the encryption key exchange protocol IKE with the counterpart apparatus with which the encryption key to be updated is shared, and records it to each of the encryption key control tables, thereby performing update of the encryption key and resetting of validity time associated with that. Meanwhile, if there is no encryption key that is close to validity time expiration in step S2, the process proceeds to step S3 in which a mean value of the CPU load during a past predetermined period of time which is measured by the CPU load measurement unit 28-1 is read, and whether the CPU load is equal to or less than a threshold value or not is checked in step S4. If the CPU load is equal to or less than the threshold value, the CPU load is determined to be small, and the process proceeds to step S5 in which an encryption key of which communication volume is equal to or less than a predetermined threshold value is searched from recorded encryption keys of the encryption key control table 24-1. If a corresponding encryption key(s) having a communication volume equal to or less than the threshold value is determined in step S6 through this encryption key search, the process proceeds to step S7 in which whether a plurality of encryption keys correspond or not is checked; and, if it is single, the process proceeds to step S9 in which, as well as the case in which it is close to validity time expiration, the encryption key exchange processing unit 22-1 is instructed to update the encryption key. If a plurality of encryption keys are determined to correspond in step S7, the encryption key having minimum communication time among them is searched, and the process similarly proceeds to step S9 in which the encryption key exchange processing unit 22-1 is instructed to update the encryption key. Upon operation initiation, for example as shown in the encryption key control table 24-1 in the center site of FIG. 7A, validity time is concentrated approximately at the same time since encryption key generation time of the encryption keys of the counterpart apparatuses is approximately the same; however, by virtue of such validity time control process, based on the state of the CPU load of the encryption communication apparatus 16-1 of the center site 10 during operation thereafter and the volumes of communication with the apparatuses of the local sites 12-1 to 12-3 which are the counterpart apparatuses, the encryption key update processes are dynamically executed before reaching validity time for the encryption keys that satisfy the conditions of encryption key update according to the CPU load and the communication volume; as a result, encryption key generation time is arbitrarily dispersed depending on the CPU load and the communication utilization, and validity time associated with this is also dispersed. Therefore, even when the validity time of the encryption keys for the plurality of apparatuses is controlled by the same validity time by setting the same communication initiation time, the validity time is dispersed through system operation; therefore, when the encryption key of a particular apparatus reaches validity time, the possibility that the validity time of the encryption key of another apparatus is very close to that and in the vicinity thereof is significantly reduced, and generation of the state in which communication cannot be performed since the encryption key cannot be updated until the validity time due to concentration of encryption key update processes can be reliably prevented.

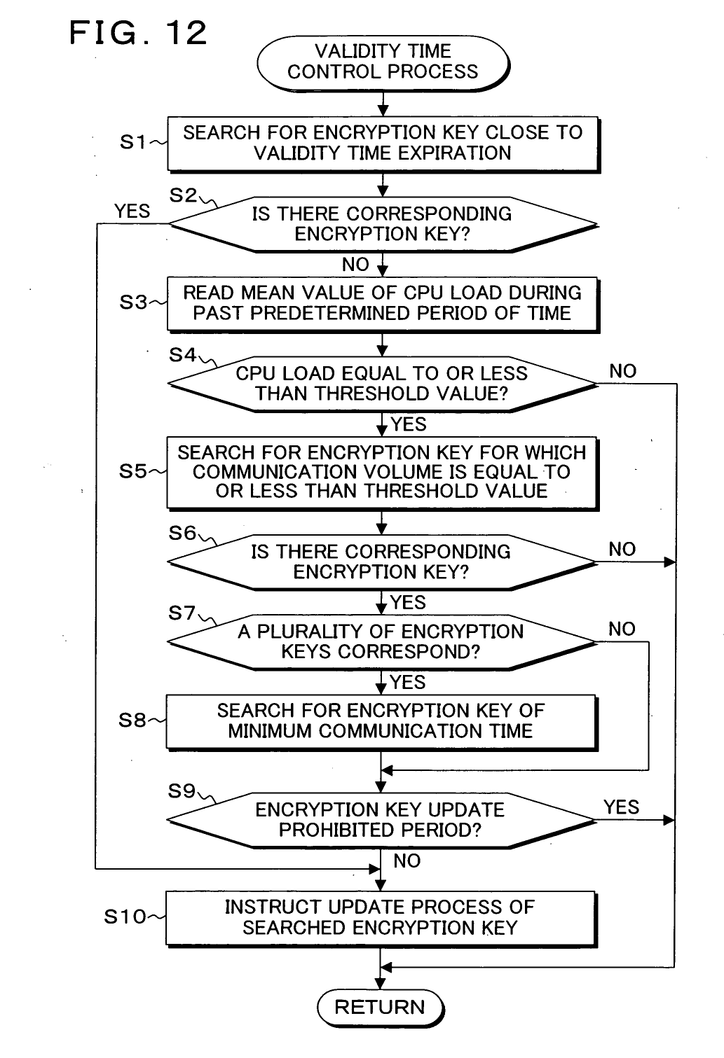

FIG. 12 is a flow chart showing another embodiment of the validity time control process in step S13 of FIGS. 9A and 9B, and this embodiment is characterized in that an encryption key update prohibited time period is set during validity time period to perform validity time control. As the validity time of an encryption key in the present embodiment, validity time according to a predetermined time period such as 24 hours or 8 hours from encryption key generation date and time is set; however, according to the update of the encryption key based on the CPU load and the communication volume in the embodiment of FIG. 11, when the two conditions are satisfied, update of the encryption key is performed even when it is in an initial stage of the validity time. However, the once-generated encryption key is meaningless unless it is used over a certain period of time; therefore, in the embodiment of FIG. 12, the encryption key update prohibited time period which is a certain period of time from initiation time of the validity time, i.e., generation time of the encryption key is set, and update of the encryption key cannot be performed during the encryption key update prohibited time period even when the conditions of the encryption key update according to the CPU load and the communication volume are satisfied. Therefore, even when encryption key update is arranged to be performed according to the CPU load and the communication volume, update of the encryption key is prohibited for a certain period of time which is the encryption key update prohibited time period from update of the encryption key, and the usage time period of the generated encryption key can be prevented from being unnecessarily shortened. In the validity time control process of FIG. 12 in which the encryption key update prohibited time period is set, although steps S1 to S8 are same as the validity time control process of FIG. 11, whether the elapsed time from encryption key generation time is the prohibited time period of the encryption key update for which elapsed time is set in advance is checked; and, if it is during the prohibited time period, the update process of the encryption key of step S10 is skipped, so that update of the encryption key during the encryption key update prohibited period is not performed. Herein, how long encryption key update prohibited time period is to be set with respect to validity time is desired to be statistically determined according to operation history in the encryption communication system of FIGS. 4A and 4B. Specifically, it can be determined so that the encryption key update prohibited time period as default is set as, for example, 50% the validity time, and the default encryption key update prohibited time period is shortened if update of encryption keys is concentrated, while the default encryption key update prohibited time period is adjusted to be extended if the encryption key update is sufficiently dispersed.

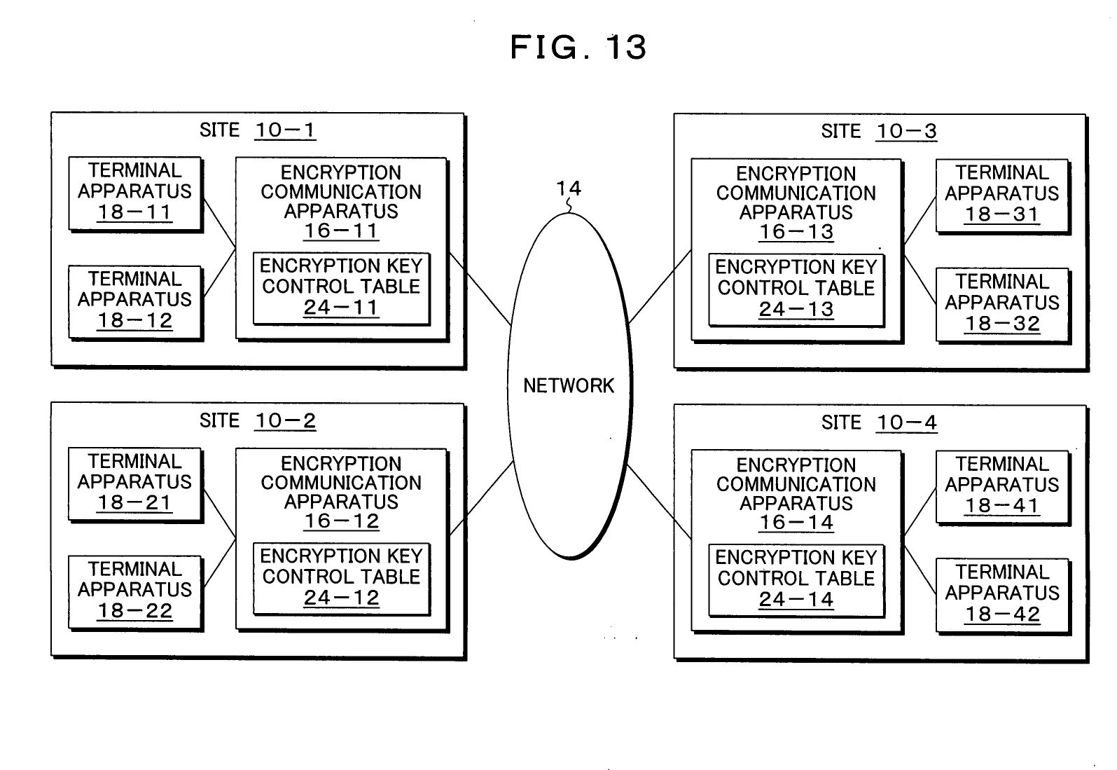

FIG. 13 is a block diagram showing another embodiment of the encryption communication system according to the present invention, and this embodiment is characterized in that validity time of encryption keys is controlled in each of sites. In FIG. 13, for example, four sites 10-1 to 10-4 are connected via the network 14, encryption communication apparatuses 16-11, 16-12, 16-13, and 16-14 are disposed in the sites 10-1 to 10-4, respectively, and two terminal apparatuses 18-11 and 18-12, terminal apparatuses 18-21 and 18-22, terminal apparatuses 18-31 and 18-32, or terminal apparatuses 18-41 and 18-42 are connected to each of them. In the encryption communication apparatuses 16-11 to 16-14, encryption key control tables 24-11, 24-12, 24-13, and 24-14 are provided, respectively. Each of the functional configurations of the encryption communication apparatuses 16-11 to 16-14 in the embodiment of FIG. 13 associated with program execution has, as well as the encryption communication apparatus 16-1 of the center site 10 in the encryption communication system of FIGS. 4A and 4B shown in FIG. 5, the frame transmitting and receiving unit 20-1, the encryption key exchange processing unit 22-1, the encryption key control table 24-1, the validity time control unit 26-1, the CPU load measurement unit 28-1, and the communication volume measurement unit 30-1. Control of validity time using the encryption key control tables 24-11 to 24-14 is performed in the encryption communication apparatuses 16-11 to 16-14, respectively; and, in order to avoid redundant validity time control, in the present embodiment, for example, validity time is controlled in the apparatus that has generated the encryption key.

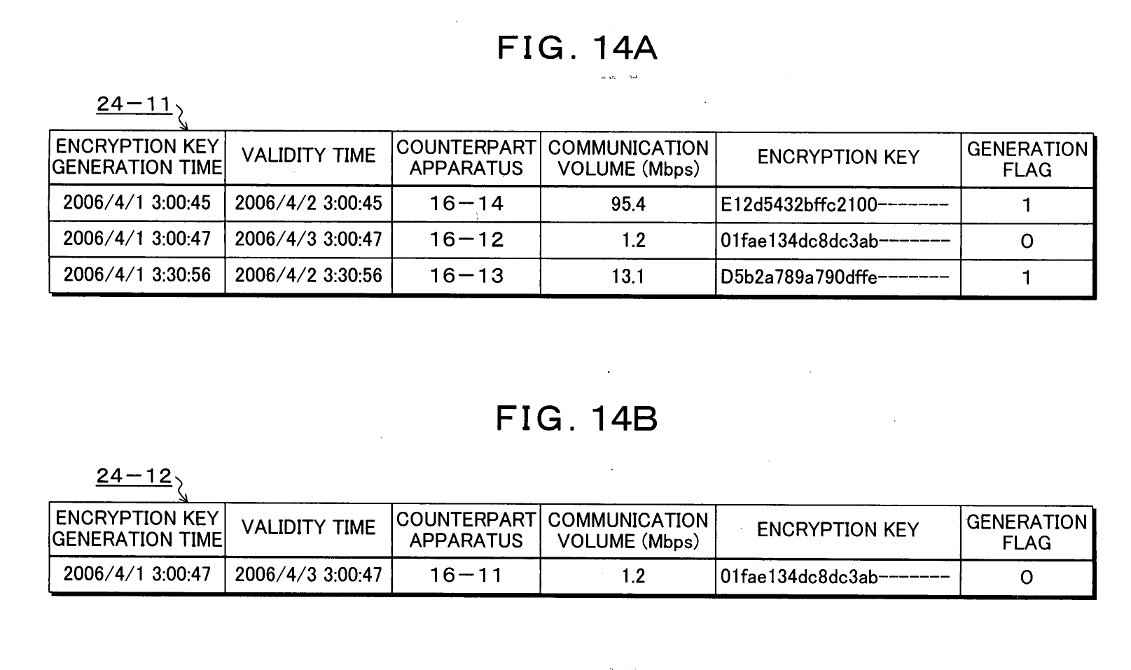

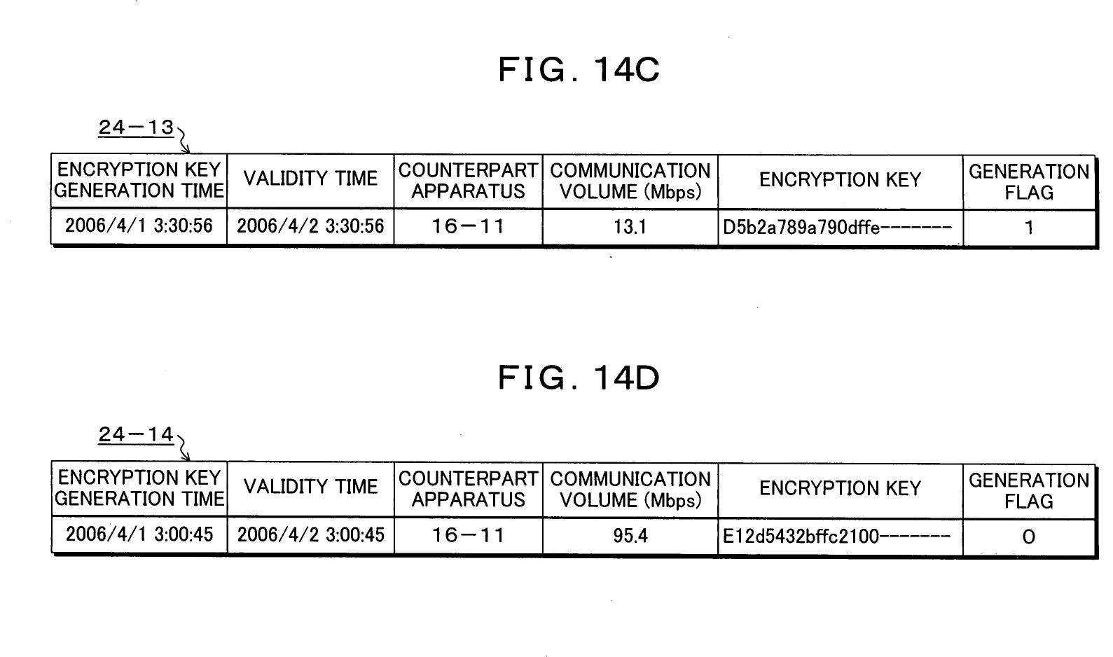

FIGS. 14A to 14D show the contents of the encryption key control tables 24-11, 24-12, 24-13, and 24-14 provided in the encryption communication apparatuses 16-11 to 16-14 of FIG. 13 in FIG. 14A, FIG. 14B, FIG. 14C, and FIG. 14D, respectively. In the encryption key control tables 24-11 to 24-14, as well as the case of the encryption communication system of FIGS. 4A and 4B, encryption key generation time, validity time, counterpart apparatuses, communication volumes, and encryption keys are recorded; however, furthermore, generation flags of the encryption keys for performing validity time control are newly provided. The generation flag of the encryption key is set to “1” in the apparatus side in which the encryption key is generated and is reset to “0” in the apparatus side to which the encryption key is passed and in which it is not generated, and control of the validity time of the encryption key is performed for the encryption key for which the generation flag is set to “1”. In the encryption key control table 24-11 provided in the encryption communication apparatus 16-11 of the site 10-1 of FIG. 14A, “1” is set for a first row and a third row in which the counterpart apparatuses are the encryption communication apparatus 16-14 of the site 10-4 and the encryption communication apparatus 16-13 of the site 10-3, and validity time is controlled for the two encryption keys thereof. Meanwhile, regarding the encryption key that is controlled in the encryption communication apparatuses 16-11 and 16-13 of the sites 10-1 and 10-3, the generation flag of the encryption key control table 24-13 of the encryption communication apparatus 16-13 of FIG. 14C which has generated the encryption key is set to “1”, and validity time is controlled in the encryption communication apparatus 16-3.

FIGS. 15A and 15B are flow charts of an encryption communication process performed in each of the encryption communication apparatuses 16-11 to 16-14 of each site of FIG. 13. The encryption communication process performed in each site is basically same as the encryption communication process of the encryption communication apparatus 16-1 of the center site 10 in FIGS. 4A and 4B shown in FIGS. 9A and 9B, and a different point is merely the point that not reception from or transmission to an encryption communication apparatus of a local site but reception or transmission from another mutually-connected encryption communication apparatus is checked in step S1 and step S2.

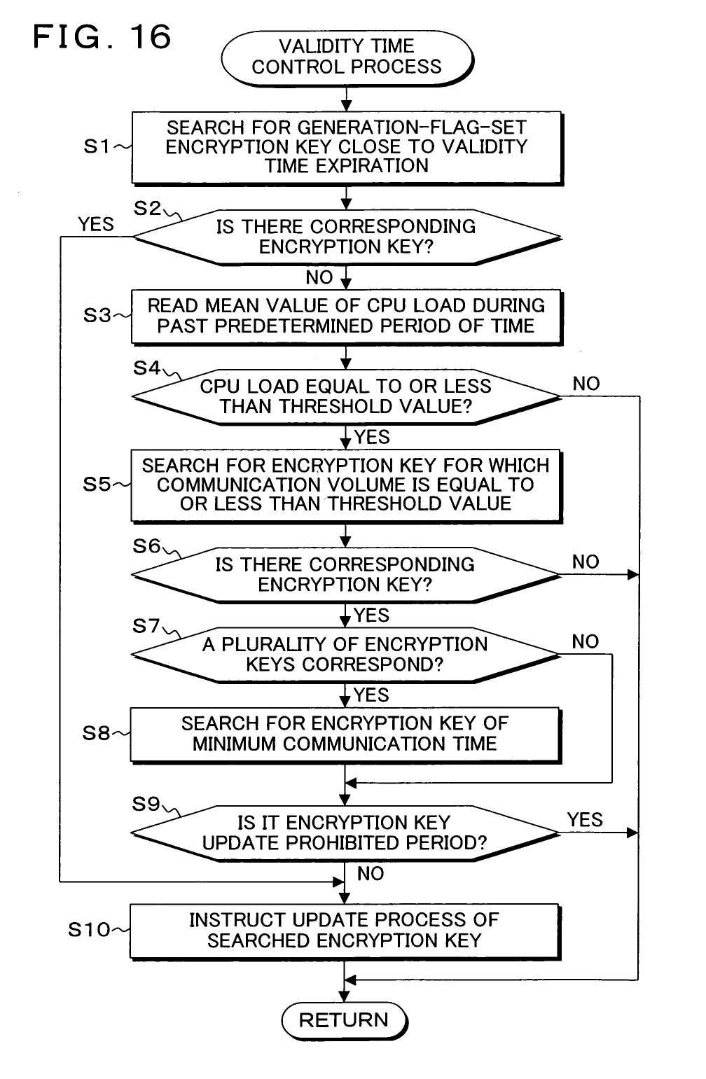

FIG. 16 is a flow chart showing details of the validity time control process in step S13 of FIGS. 15A and 15B. This validity time control process is same as the validity time control process shown in FIG. 12 in the center site of FIGS. 4A and 4B; however, a different point is that, in step S1, whether it is an encryption key close to validity time expiration or not is searched from encryption keys for which generation flags in the respective encryption key control tables 24-11 to 24-14 are set to “1” as shown in FIGS. 14A to 14D; and points other than that are the same process. In the embodiment of FIG. 16, an encryption key update prohibited time period is set, and whether it is the encryption key update prohibited time period or not is determined in step S9; however, the process of step S9 may be eliminated so that it is the same process as the validity time control process of FIG. 11. The present invention also provides a recording medium which stores the encryption communication programs shown in FIGS. 9A and 9B to FIGS. 10A and 10B and FIGS. 15A and 15B. Examples of the recording medium includes a portable-type recording medium such as a CD-ROM, a floppy disk (R), a DVD disk, a magneto-optical disk, or an IC card; a storage apparatus such as a hard disk drive provided inside/outside a computer system; a database which retains the programs via a line; another computer system and a database thereof; and an online transmission medium. Note that, although the above described embodiments employed, as an example, the shared key encryption method in which the same encryption key is used in encryption and decryption as an encryption key of encryption communication, they can be also applied to a public key method in which different encryption keys are used in encryption and decryption. Also, the above described embodiments employed, as an example, the IPSec (IP security protocol) as an encryption protocol; however, other application-dependent SSL, SSH, S/MIME, PGP, etc. may be employed. The present invention also includes arbitrary modifications that do not impair the object and advantages thereof and is not limited by the numerical values shown in the above described embodiments.

What is claimed is:

1. An encryption communication system in which a plurality of encryption communication apparatuses to which terminal apparatuses are connected are connected via a network, data received from the terminal apparatus which is a transmission source is encrypted and transmitted to the other encryption communication apparatus, and the data received from the other encryption communication apparatus is decrypted and transmitted to the terminal apparatus which is a transmission destination, the encryption communication system characterized in that,
in each of the plurality of encryption communication apparatuses,
a frame transmitting and receiving unit which encrypts and transmits the data for the other encryption communication apparatus by using an encryption key and decrypts the data received from the other encryption communication apparatus by using an encryption key, and
an encryption key exchange processing unit which generates and exchanges the encryption key in accordance with a predetermined encryption key exchange procedure involving advance negotiation with the counterpart apparatus upon initiation of first communication with the other encryption communication apparatus are provided; and,
in at least a part of the plurality of encryption communication apparatuses,
an apparatus load measurement unit which measures apparatus load,
a communication volume measurement unit which measures the volume of communication with each of the encryption communication apparatuses of the counterpart, and
a validity time control unit which sets validity time for the encryption key generated by the encryption key exchange unit, searches an encryption key of which validity time is close, and instructs the encryption key exchange processing unit to update the encryption key by generating an encryption key again, or, in the case in which there is no encryption key of which validity time is close, when the apparatus load is determined to be in a low state, searches an encryption key of the encryption communication apparatus of a counterpart for which the communication volume is small, and instructs the encryption key exchange processing unit to update the encryption key by exchanging the encryption key again are provided.

2. The encryption communication system according to claim 1, characterized in that the validity time control unit has an encryption key control table; and encryption key generation date and time, validity time, the counterpart apparatus, the communication volume, and the encryption key are recorded and controlled in the encryption key control table.

3. The encryption communication system according to claim 1, characterized in that,
when a plurality of local encryption communication apparatuses are connected to one center encryption communication apparatus so as to perform encryption communication,
in the center encryption communication apparatus, the frame transmitting and receiving unit, the encryption key exchange processing unit, the apparatus load measurement unit, the communication volume measurement unit, and the validity time control unit are provided; and,
in each of the local encryption communication apparatuses, the frame transmitting and receiving unit and the encryption key exchange processing unit are provided.

4. The encryption communication system according to claim 1, characterized in that, when encryption communication is to be performed mutually between the plurality of encryption communication apparatuses, in each of the plurality of encryption communication apparatuses, the frame transmitting and receiving unit, the encryption key exchange processing unit, the apparatus load measurement unit, the communication volume measurement unit, and the validity time control unit are provided.

5. The encryption communication system according to claim 1, characterized in that, when first reception connection is received from the other encryption communication apparatus, the encryption key exchange processing unit generates and exchanges the encryption key and instructs the validity time control unit to perform validity time control of the encryption key.

6. The encryption communication system according to claim 1, characterized in that when first transmission connection to the other encryption communication apparatus is achieved, the encryption key exchange processing unit generates and exchanges the encryption key and instructs the validity time control unit to perform validity time control of the encryption key.

7. The encryption communication system according to claim 1, characterized in that
the apparatus load measurement unit measures CPU load; and
the validity time control unit determines encryption key update timing when a mean value of the CPU load during a past predetermined period of time is lower than a predetermined value, searches the encryption communication apparatus of the counterpart having the communication volume which is equal to or less than a predetermined value and minimum, and instructs the encryption key exchange unit to update the encryption key by generating an encryption key again.

8. The encryption communication system according to claim 1, characterized in that the communication volume measurement unit measures a bit rate per unit time as the communication volume.

9. The encryption communication system according to claim 1, characterized in that the validity time control unit prohibits encryption key update for a predetermined period of time from update of the encryption key.

10. The encryption communication system according to claim 1, characterized in that the encryption key exchange processing unit generates and exchanges the encryption key of a shared key encryption method which uses the same encryption key in encryption and decryption.

11. An encryption communication apparatus in which a plurality of encryption communication apparatuses to which terminal apparatuses are connected are connected via a network, data received from the terminal apparatus which is a transmission source is encrypted and transmitted to the other encryption communication apparatus, and the data received from the other encryption communication apparatus is decrypted and transmitted to the terminal apparatus which is a transmission destination, the encryption communication apparatus characterized by having a transmitting and receiving unit which encrypts and transmits the data for the other encryption communication apparatus by using an encryption key and decrypts the data received from the other encryption communication apparatus by using an encryption key;
an encryption key exchange processing unit which generates and exchanges the encryption key in accordance with a predetermined encryption key exchange procedure involving advance negotiation with the counterpart apparatus upon initiation of first communication with the other encryption communication apparatus are provided;
an apparatus load measurement unit which measures apparatus load;
a communication volume measurement unit which measures the volume of communication with each of the encryption communication apparatuses of the counterpart; and
a validity time control unit which sets validity time for the encryption key generated by the encryption key exchange unit, searches an encryption key of which validity time is close, and instructs the encryption key exchange processing unit to update the encryption key by generating an encryption key again, or, in the case in which there is no encryption key of which validity time is close, when the apparatus load is determined to be in a low state, searches an encryption key of the encryption communication apparatus of a counterpart for which the communication volume is small, and instructs the encryption key exchange processing unit to update the encryption key by exchanging the encryption key again.

12. The encryption communication apparatus according to claim 11, characterized in that the validity time control unit has an encryption key control table; and encryption key generation date and time, validity time, the counterpart apparatus, the communication volume, and the encryption key are recorded and controlled in the encryption key control table.

13. The encryption communication apparatus according to claim 11, characterized in that, when first reception connection is received from the other encryption communication apparatus, the encryption key exchange processing unit generates and exchanges the encryption key and instructs the validity time control unit to perform validity time control of the encryption key.

14. The encryption communication apparatus according to claim 11, characterized in that when first transmission connection to the other encryption communication apparatus is achieved, the encryption key exchange processing unit generates and exchanges the encryption key and instructs the validity time control unit to perform validity time control of the encryption key.

15. The encryption communication apparatus described in claim 11, characterized in that
the apparatus load measurement unit measures CPU load; and
the validity time control unit determines encryption key update timing when a mean value of the CPU load during a past predetermined period of time is lower than a predetermined value, searches the encryption communication apparatus of the counterpart having the communication volume which is equal to or less than a predetermined value and minimum, and instructs the encryption key exchange unit to update the encryption key by generating an encryption key again.

16. (Prohibited Time Period of Encryption Key Update)
The encryption communication apparatus described in claim 11, characterized in that the validity time control unit prohibits encryption key update for a predetermined period of time from update of the encryption key.

17. An encryption communication method in which a plurality of encryption communication apparatuses to which terminal apparatuses are connected are connected via a network, data received from the terminal apparatus which is a transmission source is encrypted and transmitted to the other encryption communication apparatus, and the data received from the other encryption communication apparatus is decrypted and transmitted to the terminal apparatus which is a transmission destination, the encryption communication method characterized by including a transmitting and receiving step in which the data for the other encryption communication method is encrypted and transmitted by using an encryption key, and the data received from the other encryption communication apparatus is decrypted by using the encryption key;
an encryption key exchange processing step in which the encryption key is generated and exchanged in accordance with a predetermined encryption key exchange procedure involving advance negotiation with the counterpart apparatus upon initiation of first communication with the other encryption communication apparatus;
an apparatus load measurement step in which apparatus load is measured;
a communication volume measurement step in which the volume of communication with each of the encryption communication apparatuses of the counterpart is measured;
a validity time control step in which validity time is set for the encryption key generated in the encryption key exchange step, an encryption key of which validity time is close is searched, and the encryption key exchange processing step is instructed to update the encryption key by generating an encryption key again, or, in the case in which there is no encryption key of which validity time is close, when the apparatus load is determined to be in a low state, an encryption key of the encryption communication apparatus of a counterpart for which the communication volume is small is searched, and the encryption key exchange processing step is instructed to update the encryption key by exchanging the encryption key again.

18. The encryption communication method according to claim 17, characterized in that
in the apparatus load measurement step, CPU load is measured; and
in the validity time control step, encryption key update timing is determined when a mean value of the CPU load during a past predetermined period of time is lower than a predetermined value, the encryption communication apparatus of the counterpart having the communication volume which is equal to or less than a predetermined value and minimum is searched, and the encryption key exchange step is instructed to update the encryption key by generating an encryption key again.

19. A computer-readable storage medium which stores an encryption communication program characterized by causing a computer of an encryption communication apparatus in which a plurality of encryption communication apparatuses to which terminal programs are connected are connected via a network, data received from the terminal apparatus which is a transmission source is encrypted and transmitted to the other encryption communication apparatus, and the data received from the other encryption communication apparatus is decrypted and transmitted to the terminal apparatus which is a transmission destination, to execute
a transmitting and receiving step in which the data for the other encryption communication apparatus is encrypted and transmitted by using an encryption key, and the data received from the other encryption communication apparatus is decrypted by using the encryption key;
an encryption key exchange processing step in which the encryption key is generated and exchanged in accordance with a predetermined encryption key exchange procedure involving advance negotiation with the counterpart apparatus upon initiation of first communication with the other encryption communication apparatus;
an apparatus load measurement step in which apparatus load is measured;
a communication volume measurement step in which the volume of communication with each of the encryption communication apparatuses of the counterpart is measured;
a validity time control step in which validity time is set for the encryption key generated in the encryption key exchange step, an encryption key of which validity time is close is searched, and the encryption key exchange processing step is instructed to update the encryption key by generating an encryption key again, or, in the case in which there is no encryption key of which validity time is close, when the apparatus load is determined to be in a low state, the encryption communication apparatus of a counterpart for which the communication volume is small is searched, and the encryption key exchange processing step is instructed to update the encryption key by exchanging the encryption key again.

20. The storage medium according to claim 19, characterized in that
in the apparatus load measurement step, CPU load is measured; and
in the validity time control step, encryption key update timing is determined when a mean value of the CPU load during a past predetermined period of time is lower than a predetermined value, the encryption communication apparatus of the counterpart having the communication volume which is equal to or less than a predetermined value and minimum is searched, and the encryption key exchange step is instructed to update the encryption key by generating an encryption key again.

21. An encryption communication apparatus which is connected to another encryption communication apparatus via a network, is connected to a terminal apparatus, encrypts data received from the terminal apparatus and transmits the data to the other encryption communication apparatus, and decrypts data received from the other encryption communication apparatus and transmits the data to the terminal apparatus, the encryption communication apparatus characterized by having a transmitting and receiving unit which encrypts the data to be transmitted to the other encryption communication apparatus by using an encryption key and transmits the data, and decrypts the data received from the other encryption communication apparatus by using the encryption key;
an encryption key processing unit which generates the encryption key used in data transmission and reception with the other encryption communication apparatus in accordance with an encryption key exchange procedure;
an apparatus load measurement unit which measures the load of the apparatus per se;
a communication volume measurement unit which measures a communication volume of the other encryption communication apparatus; and
a control unit which, when a state in which load is low is determined by the apparatus load measurement unit, searches the other encryption communication apparatus having a small communication volume based on a measurement result of the communication volume measurement unit, and instructs the encryption key exchange processing unit to update the encryption key which is shared with the other encryption communication apparatus.

22. An information processing apparatus which is connected to another apparatus and transmits/receives information to or from the other apparatus, the information processing apparatus characterized by having
a transmitting and receiving unit which transmits transmitted information encrypted by an encryption key to the other apparatus and decrypts received information from the other apparatus by the encryption key;
an apparatus load measurement unit which measures load of the apparatus per se; and
a control unit which, when the state in which the load is low is determined by the apparatus load measurement unit, searches the other apparatus having a small communication volume and updates the encryption key used in information transmission/reception to or from the other apparatus.

23. The information processing apparatus described in claim 22, characterized in that
the information processing apparatus is connected to a plurality of the other apparatuses; and
the encryption key processing unit generates different encryption keys respectively for the plurality of other apparatuses.
